(19) United States
(12) Patent Application Publication
(10) Pub. No.: US 2026/0195946 A1
(43) Pub. Date: Jul. 9, 2026

(54) METHOD FOR DISPLAYING AN IMAGE AND ELECTRONIC DEVICE FOR THE IMAGE

(71) Applicant: Samsung Electronics Co., Ltd., Suwon-si (KR)

(72) Inventors: Suho CHO, Suwon-si (KR); Jeongrok JANG, Suwon-si (KR); Minkyo SEO, Suwon-si (KR); Jinsol PARK, Suwon-si (KR)

(21) Appl. No.: 19/531,263

(22) Filed: Feb. 5, 2026

Related U.S. Application Data
(63) Continuation of application No. PCT/KR2026/000476, filed on Jan. 8, 2026.

(30) Foreign Application Priority Data
Jan. 8, 2025 (KR) 10-2025-0002877

(51) Int. Cl. G06T 11/60; G06F 3/04845; G06F 3/14; G06T 5/60

(52) U.S. Cl. CPC G06T 11/60; G06F 3/04845; G06F 3/1415; G06T 5/60; G06T 2207/20084

(57) ABSTRACT

A method of displaying an image includes obtaining an image prior to a current time point, based on an input corresponding to a request for image modification while displaying the image, obtaining a knowledge graph corresponding to the image prior to the current time point and a scenario corresponding to the image prior to the current time point through a first artificial intelligence (AI) model, based on the obtained image prior to the current time point, and obtaining an image after the current time point through a second AI model, based on the knowledge graph corresponding to the image prior to the current time point, the scenario corresponding to the image prior to the current time point, and information corresponding to the image modification, according to the information corresponding to the image modification related to the input.

### CROSS-REFERENCE TO RELATED APPLICATIONS

This application is a continuation of International Application No. PCT/KR2026/000476 designating the United States, filed on Jan. 8, 2026, in the Korean Intellectual Property Receiving Office and claiming priority to Korean Patent Application No. 10-2025-0002877, filed on Jan. 8, 2025, in the Korean Intellectual Property Office, the disclosures of each of which are incorporated by reference herein in their entireties.

### BACKGROUND

### Field

The disclosure relates to a method and an electronic device for displaying an image.

### Description of Related Art

Generative artificial intelligence (AI) is technology that learns the structures and patterns of big data and, based on input data, generates new synthetic data. Generative AI generates human-level results for a variety of tasks involving text, images, voice, video, music, and the like. For example, a generative model generates new data based on given data such as text, images, voice, video, or music.

A scenario is a series of events or a sequence of work flow and is a concept mainly used in the production of content such as movies, dramas, advertisements, or games. A scenario describes the development of a story, including dialogue, action, and environment, and indicates how work will unfold based on this. Recently, users have tended to want a variety of content according to their tastes, interests, or requirements, and there is a demand for the development of technology that provides customized content to each user by generating customized scenarios for each user.

### SUMMARY

According to an example embodiment of the disclosure, a method of displaying an image may be provided.

The method according to an example embodiment of the disclosure may include obtaining an image prior to a current time point, based on an input corresponding to a request for image modification while displaying the image.

The method according to an example embodiment of the disclosure may include obtaining a knowledge graph corresponding to the image prior to the current time point and a scenario corresponding to the image prior to the current time point through a first artificial intelligence (AI) model, based on the obtained image prior to the current time point.

The method according to an example embodiment of the disclosure may include obtaining an image after the current time point through a second AI model, based on the knowledge graph corresponding to the image prior to the current time point, the scenario corresponding to the image prior to the current time point, and information corresponding to the image modification, according to the information corresponding to the image modification related to the input.

According to an example embodiment of the disclosure, an electronic device may be provided.

The electronic device according to an example embodiment of the disclosure may include at least one processor, comprising processing circuitry, and memory storing a plurality of instructions.

In the electronic device according to an example embodiment of the disclosure, the at least one processor individually or collectively executes the instructions to cause the electronic device to obtain an image prior to a current time point, based on an input corresponding to a request for image modification while displaying the image.

In the electronic device according to an example embodiment of the disclosure, the at least one processor individually or collectively executes the instructions to cause the electronic device to, based on the obtained image prior to the current time point, obtain a knowledge graph corresponding to the image prior to the current time point and a scenario corresponding to the image prior to the current time point through a first AI model.

In the electronic device according to an example embodiment of the disclosure, the at least one processor individually or collectively executes the instructions to cause the electronic device to, according to the information corresponding to the image modification related to the input, obtain an image after the current time point through a second AI model, based on the knowledge graph corresponding to the image prior to the current time point, the scenario corresponding to the image prior to the current time point, and information corresponding to the image modification.

According to an example embodiment of the disclosure, a non-transitory computer-readable recording medium having recorded thereon a program for causing a computer to perform any one of the methods described above and below may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example operation in which an electronic device generates and outputs a new image after a current time point according to various embodiments.

FIG. 2 is a flowchart illustrating an example method of displaying an image, according to various embodiments.

FIG. 3 is a block diagram illustrating an example configuration of an electronic device according to various embodiments.

FIG. 4 is a block diagram illustrating an example configuration of an electronic device according to various embodiments.

FIG. 5 is a flowchart illustrating an example method, performed by an electronic device, of obtaining information about an image prior to a current time point, according to various embodiments.

FIG. 6 is a diagram illustrating an example method, performed by an electronic device, of obtaining information about an image prior to a current time point, according to various embodiments.

FIG. 7 is a flowchart illustrating an example method, performed by an electronic device, of obtaining information about an image prior to a current time point, according to various embodiments.

FIG. 8 is a diagram illustrating an example method, performed by an electronic device, of obtaining information about an image prior to a current time point, according to various embodiments.

FIG. 9 is a flowchart illustrating an example method, performed by an electronic device, of changing information about a current image, according to various embodiments.

FIG. 10 is a diagram illustrating an example method, performed by an electronic device, of changing information about a current image, according to various embodiments.

FIG. 11 is a flowchart illustrating an example method, performed by an electronic device, of changing information about a current image, according to various embodiments.

FIG. 12 is a diagram illustrating an example method, performed by an electronic device, of changing information about a current image, according to various embodiments.

FIG. 13 is a flowchart illustrating an example method, performed by an electronic device, of generating a new image after a current time point, according to various embodiments.

FIG. 14 is a diagram illustrating an example method, performed by an electronic device, of generating a new image after a current time point, according to various embodiments.

FIG. 15 is a flowchart illustrating an example method, performed by an electronic device, of generating a new image after a current time point, according to various embodiments.

FIG. 16A is a diagram illustrating an example method, performed by an electronic device, of obtaining information about an original image after a current time point, according to various embodiments.

FIG. 16B is a diagram illustrating an example method, performed by an electronic device, of generating a new image after a current time point, according to various embodiments.

FIG. 17A is a flowchart illustrating an example method, performed by an electronic device, of calculating and verifying a similarity between a generated image and a scenario for an original image, according to various embodiments.

FIG. 17B is a flowchart illustrating an example method, performed by an electronic device, of calculating and verifying a similarity between a generated image and a scenario for an original image, according to various embodiments.

FIG. 18 is a flowchart illustrating an example method, performed by an electronic device, of calculating and verifying a similarity between a generated image and a scenario for an original image, according to various embodiments.

FIG. 19 is a block diagram illustrating an example configuration of a processor in terms of learning and processing of a neural network according to various embodiments.

FIG. 20A is a diagram illustrating an example in which a data learner is loaded on a server and a data processor is loaded on a user computing device, according to various embodiments.

FIG. 20B is a diagram illustrating an example in which both the data learner and the data processor are loaded on the server, according to various embodiments.

### DETAILED DESCRIPTION

Throughout the disclosure, the expression “at least one of a, b or c” indicates only a, only b, only c, both a and b, both a and c, both b and c, all of a, b, and c, or variations thereof.

Hereinafter, various example embodiments of the disclosure will be described in greater detail with reference to the accompanying drawings. However, the disclosure may be implemented in various different forms and is not limited to the example embodiments of the disclosure described herein.

As for the terms as used in the disclosure, common terms that are currently widely used are selected as much as possible while taking into account the functions in the disclosure. However, these terms may refer to various other terms depending on the intention of those of ordinary skill in the art, precedents, the emergence of new technology, and the like. Therefore, the terms as used herein should be defined based on the meaning of the terms and the description throughout the disclosure rather than simply the names of the terms.

The terms as used in the disclosure are used to describe particular embodiments of the disclosure, and are not intended to limit the disclosure.

Throughout the disclosure, it will be understood that when a portion is referred to as being “connected to” another portion, it may be “directly connected to” the other portion or “electrically connected to” the other portion with intervening portions therebetween.

The term “the” and similar demonstratives as used in the present disclosure, particularly in the patent claims, may refer to both the singular and the plural. Operations of methods may be performed in any suitable order unless otherwise indicated herein or otherwise clearly contradicted by context, and are not necessarily limited to the stated order. The disclosure is not limited by the order of operations described herein.

The expression “in an embodiment of the disclosure” appearing in various places in the present disclosure does not necessarily all refer to the same embodiment of the disclosure.

Various embodiments of the disclosure may be represented by functional block configurations and various processes. Some or all of such functional blocks may be implemented in any number of hardware and/or software configurations that perform particular functions. For example, the functional blocks of the disclosure may be implemented by one or more microprocessors or may be implemented by circuitry configurations for certain functions. In addition, for example, the functional blocks of the disclosure may be implemented in various programming or scripting languages. The functional blocks may be implemented as algorithms to be executed by one or more processors. In addition, the disclosure may employ conventional technologies for electronic environment setting, signal processing, and/or data processing. The terms such as “mechanism,” “element,” “means,” and “configuration” may be used broadly and are not limited to mechanical and physical configurations.

Connecting lines or connecting members illustrated in the drawings are intended to represent functional connections and/or physical or circuit connections. In an actual device, connecting lines or connecting members illustrated in the drawings may represent connections between components by means of a variety of functional, physical, or circuit connections that may be substituted or added.

The terms such as “unit” and “module” described in the disclosure may refer, for example, to units that process at least one function or operation, and may be implemented as hardware, software, or a combination of hardware and software.

In the disclosure, the “processor” may include various processing circuitries and/or a plurality of processors. For example, the term “processor” as used herein, including the claims, may include various processing circuitry, including at least one processor. One or more processors in the at least one processor may be configured to individually and/or collectively perform the various functions described herein in a distributed manner. As used herein, the “processor,” “at least one processor,” and “one or more processors” may be configured to perform various functions. However, these terms may include, without limitation, a situation where one processor performs some functions and other processor(s) perform other functions, and a situation where a single processor may perform all the functions. In addition, the at least one processor may include a combination of processors that perform the disclosed various functions in a distributed manner. The at least one processor may execute program instructions to accomplish or perform various functions.

In the disclosure, artificial intelligence (AI) technology may include machine learning (deep learning) technology that uses an algorithm to classify and learn the features of input data on its own, and element technologies that mimic the cognitive and judgment functions of the human brain by utilizing machine learning algorithms. The element technologies may include, for example, at least one of linguistic understanding technology that recognizes human language and text, visual understanding technology that recognizes objects like human vision, inference or prediction technology that determines, logically infers, and predicts information, knowledge representation technology that processes human experience information into knowledge data, or motion control technology that controls autonomous driving of vehicles and motions of robots. Linguistic understanding is technology that recognizes, applies, and processes human language and text and includes natural language processing, machine translation, dialogue system, query and answering, speech recognition and synthesis, and the like. Visual understanding is technology that recognizes and processes objects like human vision and includes object recognition, object tracking, image retrieval, person recognition, scene understanding, spatial understanding, image enhancement, and the like. Inference or prediction is technology that determines, logically infers, and predicts information and includes knowledge/probability-based inference, optimization prediction, preference-based planning, recommendation, and the like. Knowledge representation is technology that automatically processes human experience information into knowledge data and includes knowledge construction (data generation and classification), knowledge management (data utilization), and the like.

The predefined operation rule or AI model is made through learning. The expression “being made through learning” may refer, for example, to the predefined operation rule or AI model configured to perform desired characteristics (or purposes) being made in such a manner that a basic AI model is trained using a large number of training data by a learning algorithm. Such learning may be performed by the device itself on which the AI according to the disclosure is performed, or may be performed through a separate server and/or system. Examples of the learning algorithm may include supervised learning, unsupervised learning, semi-supervised learning, or reinforcement learning, but the disclosure is not limited to the examples described above.

The AI model may include a plurality of neural network layers. Each of the neural network layers has a plurality of weights and performs neural network operations through operations between the plurality of weights and an operation result of a previous layer. The plurality of weights that the plurality of neural network layers have may be optimized by the learning result of the AI model. For example, the plurality of weights may be updated so that a loss value or a cost value obtained by the AI model during the learning process is reduced or minimized. An artificial neural network may include, for example, and without limitation, a deep neural network (DNN). Examples of the artificial neural network may include a convolutional neural network (CNN), a recurrent neural network (RNN), a restricted Boltzmann machine (RBM), a deep belief network (DBN), a bidirectional recurrent deep neural network (BRDNN), deep Q-networks, etc., but the disclosure is not limited thereto.

Hereinafter, the disclosure is described in greater detail with reference to the attached drawings.

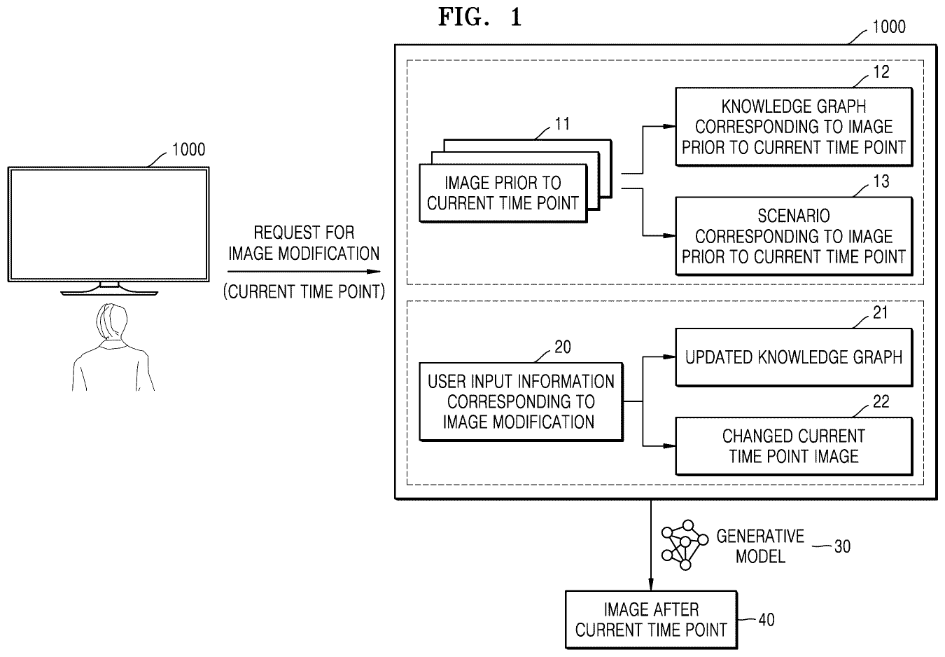

FIG. 1 is a diagram illustrating an example operation in which an electronic device 1000 generates and outputs a new image after a current time point according to various embodiments.

Referring to FIG. 1, the electronic device 1000 according to an embodiment of the disclosure may generate and output an image after a current time point according to a user input corresponding to a request for image modification after the current time point while displaying an image.

The electronic device 1000 according to an embodiment of the disclosure may be implemented in various types and forms including a display. The electronic device 1000 may include devices capable of displaying information on a display, such as a smart television (TV), a smartphone, a tablet personal computer (PC), a personal digital assistant (PDA), a laptop PC, a glasses-type display, a head mounted display (HMD), or the like, but the disclosure is not limited thereto. For example, the electronic device 1000 may be implemented in various types and forms capable of being connected to the display in a wired/wireless manner. For example, the electronic device 1000 may include devices capable of being connected to the display, such as a set-top box or a desktop PC, in a wired/wireless manner and displaying information, but the disclosure is not limited.

Upon receiving an input (e.g., a user input) corresponding to the request for image modification, the electronic device 1000 according to an embodiment of the disclosure may obtain, based on an image 11 prior to the current time point, a knowledge graph 12 corresponding to the image prior to the current time point and a scenario 13 corresponding to the image prior to the current time point.

For example, the electronic device 1000 may provide a user interface that allows a user to input the request for image modification and may receive a user input of requesting image modification through the user interface.

The knowledge graph 12 corresponding to the image prior to the current time point may include a knowledge graph based on the image prior to the current time point or a knowledge graph for the image 11 prior to the current time point. The scenario 13 corresponding to the image prior to the current time point may include a scenario based on the image prior to the current time point or a scenario for the image prior to the current time point.

The electronic device 1000 according to an embodiment of the disclosure may obtain information 20 corresponding to image modification after the current time point, based on the user input. In an embodiment of the disclosure, the information 20 corresponding to image modification after the current time point may include an updated knowledge graph 21 and/or a changed current time point image 22.

The electronic device 1000 according to an embodiment of the disclosure may obtain an image 40 after the current time point through a generative model 30, based on the obtained knowledge graph 12 corresponding to the image prior to the current time point, the obtained scenario 13 corresponding to the image prior to the current time point, and the obtained information 20 corresponding to image modification after the current time point. For example, the electronic device 1000 may generate and output the image 40 after the current time point.

In the disclosure, the “generative AI” may refer to AI technology capable of generating new text, images, etc. in response to input data (e.g., text, images, etc.). In the disclosure, the “generative model” may refer to a neural network model that implements generative AI technology. The generative model may generate new data having features similar to the input data or new data corresponding to the input data by learning the patterns and structure of training data.

According to an embodiment of the disclosure, because the electronic device 1000 may generate the image 40 after the current time point, based on the knowledge graph 12 analyzed from the images, text, and voice obtained from the image 11 prior to the current time point, various types of information may be taken into account, compared to a case where only information obtained by performing natural language processing on the image prior to the current time point is taken into account. According to an embodiment of the disclosure, because the electronic device 1000 uses the generative model 30 to generate a subsequent image based on various forms of information, such as the knowledge graph 12 corresponding to the image prior to the current time point and the scenario 13 corresponding to the image prior to the current time point, a subsequent image with a relatively higher degree of freedom may be generated, compared to a case where a subsequent image is generated based on a particular template.

According to an embodiment of the disclosure, the electronic device 1000 may generate a user-customized subsequent image by obtaining the information 20 corresponding to image modification through the user input. According to an embodiment of the disclosure, the electronic device 1000 may obtain a user input for modification information of an external image of an entity appearing in an image and/or modification information in a text form, and may generate a subsequent image reflecting a modification request for entire content by generating the image 40 after the current time point based on a modified external image of the entity and/or an updated knowledge graph.

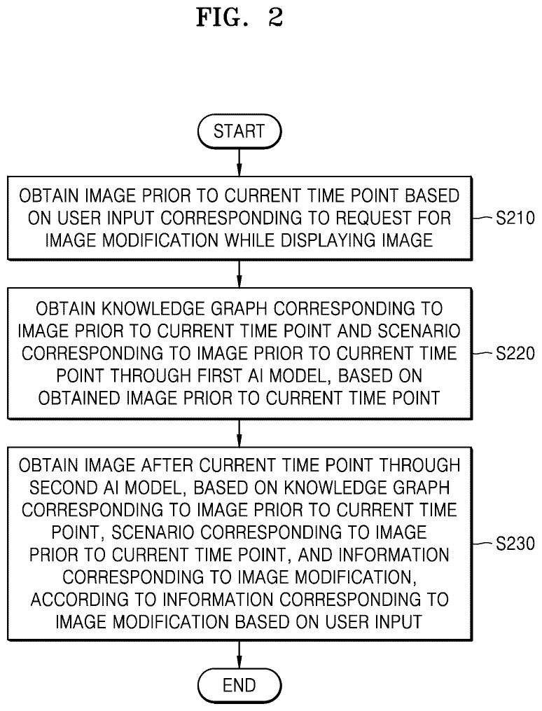

FIG. 2 is a flowchart illustrating an example method of displaying an image, according to various embodiments.

In operation S210 of FIG. 2, the electronic device 1000 may obtain an image prior to a current time point based on a user input corresponding to a request for image modification while displaying an image.

In an embodiment of the disclosure, the image displayed on the electronic device 1000 may be content received from a broadcasting station or content received from an external device, such as an external server or an external storage medium.

In the disclosure, the “current time point” may refer, for example, to a time point when the user inputs the request for image modification while displaying the image on the electronic device 1000. According to an embodiment of the disclosure, the electronic device 1000 may obtain an image prior to the current time point so as to obtain a variety of information about the image prior to the current time point. Accordingly, the electronic device 1000 may refer to a variety of information about the image prior to the current time point when generating the image after the current time point.

In operation S220 of FIG. 2, the electronic device 1000 may, based on the obtained image prior to the current time point, obtain a knowledge graph corresponding to the image prior to the current time point and a scenario corresponding to the image prior to the current time point through a first AI model.

In the disclosure, the “knowledge graph” may refer, for example, to a knowledge base that may be expressed using a visually appealing graphical description. The knowledge graph may organize information in the form of nodes, knowledge, clusters, topics, subtopics, and keywords in the electronic device 1000. In the knowledge graph, the clusters or nodes may represent individual knowledge in at least one domain, such as a general topic, a particular topic, a place, an organization, a sport, a team, a job, or a movie, but the disclosure is not limited thereto. The knowledge graph may include a form implemented by data visualization and may represent a network of entities, e.g., objects, events, situations, or concepts and may represent a relationship that exists therebetween.

In the disclosure, the “scenario” refers to a series of events or a sequence of work flow. The scenario may describe the development of a story, including dialogue, action, and environment, and may indicate how work will unfold based on this.

In an embodiment of the disclosure, the first AI model may receive the image prior to the current time point as input and may generate the knowledge graph corresponding to the image prior to the current time point. The first AI model may receive the image prior to the current time point as input and may generate the scenario corresponding to the image prior to the current time point. In an embodiment of the disclosure, the first AI model may receive the image prior to the current time point as input and may generate both the knowledge graph corresponding to the image prior to the current time point and the scenario corresponding to the image prior to the current time point.

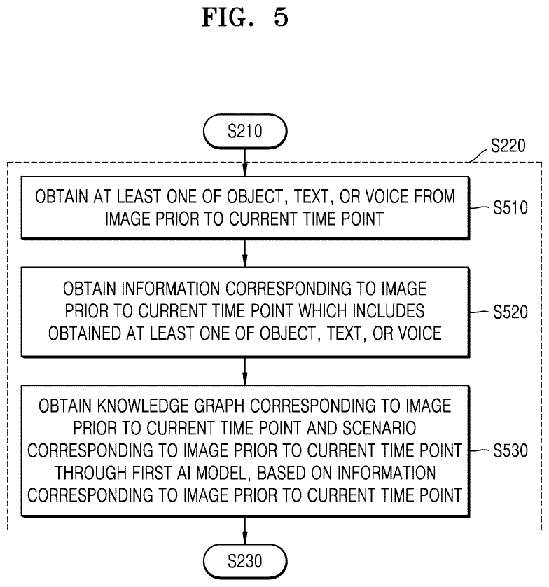

The first AI model may execute an algorithm that generates, based on an input image, a knowledge graph corresponding to the image and a scenario corresponding to the image. The first AI model may be an AI model pre-trained to generate, based on information about the input image, the knowledge graph corresponding to the image and the scenario corresponding to the image. For example, the first AI model may be a generative model. Operation S220 is described in greater detail below with reference to FIGS. 5 to 8.

In operation S230 of FIG. 2, the electronic device 1000 may, according to information corresponding to image modification after the current time point based on the user input, obtain an image after the current time point through a second AI model, based on the knowledge graph corresponding to the image prior to the current time point, the scenario corresponding to the image prior to the current time point, and the information corresponding to image modification after the input current time point. In an embodiment of the disclosure, the electronic device 1000 may generate a new image after the current time point through the second AI model according to the information corresponding to image modification after the current time point based on the user input. The electronic device 1000 may output the new image after the current time point which is generated through the second AI model.

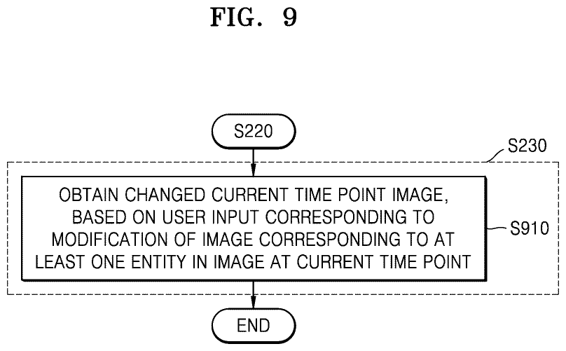

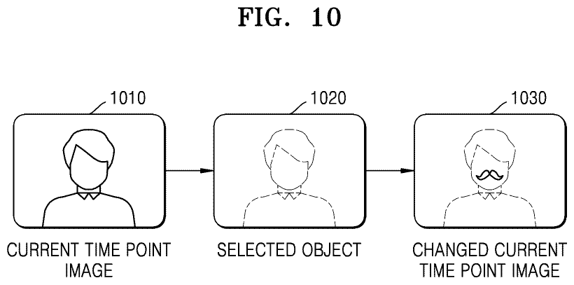

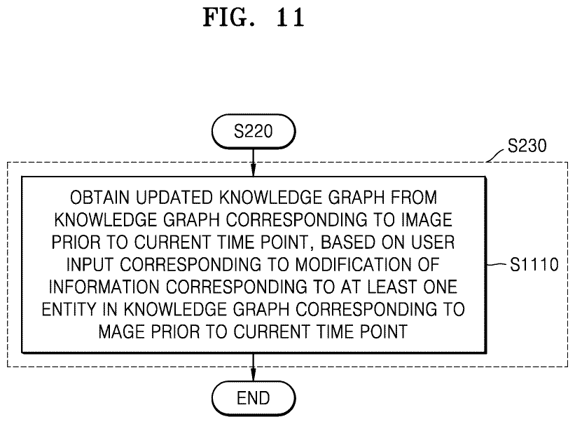

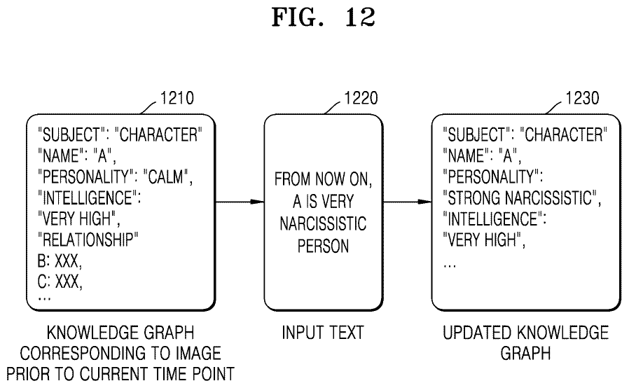

In an embodiment of the disclosure, the information corresponding to image modification after the current time point based on the user input may include an updated knowledge graph and/or a changed current time point image. For example, the electronic device 1000 may obtain the changed current time point image by receiving the user input of inputting modifications to the image at the current time point. The operation of obtaining the changed current time point image is described in greater detail below with reference to FIGS. 9 and 10. For example, the electronic device 1000 may obtain an updated knowledge graph by receiving a user input of inputting modifications to non-image matters. The operation of obtaining the updated knowledge graph is described in greater detail below with reference to FIGS. 11 and 12.

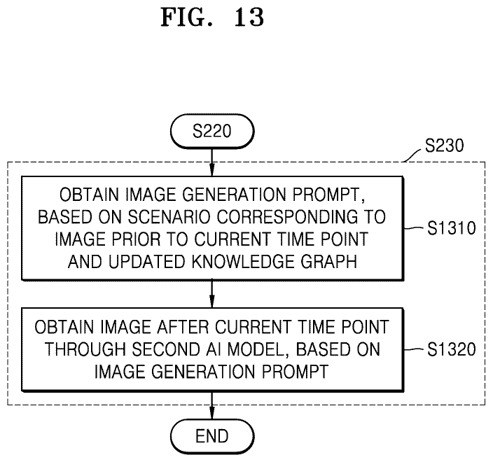

In an embodiment of the disclosure, the electronic device 1000 may generate an image generation prompt based on the updated knowledge graph and the scenario corresponding to the image prior to the current time point. The electronic device 1000 may generate the new image after the current time point through the second AI model, based on the image generation prompt and the changed current time point image. In an embodiment of the disclosure, the second AI model may be a generative model. The operation of generating the new image after the current time point is described in detail with reference to FIGS. 13 to 18.

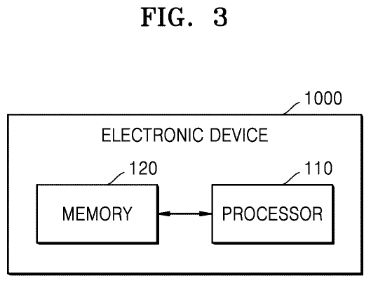

FIG. 3 is a block diagram illustrating an example configuration of an electronic device 1000 according to various embodiments.

Referring to FIG. 3, the electronic device 1000 according to an embodiment of the disclosure may include a processor (e.g., including processing circuitry) 110 and memory 120.

The memory 120 may store programs for processing and control by the processor 110 and may store data input to or output from the electronic device 1000. Furthermore, the memory 120 may store data necessary for the operations of the electronic device 1000.

The memory 120 may include at least one type of storage medium selected from flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, magnetic disc, and optical disc.

The processor 110 may include various processing circuitry and control the overall operations of the electronic device 1000. For example, the processor 110 may execute one or more instructions stored in the memory 120 to perform the functions of the electronic device 1000 described in the disclosure.

In an embodiment of the disclosure, the processor 110 may store one or more instructions in the memory 120 provided therein and may execute the one or more instructions stored in the memory 120 provided therein to control the operations of the electronic device 1000. In other words, the processor 110 may execute at least one instruction or program, which is stored in the memory 120 or an internal memory provided inside the processor 110, to perform a predefined operation.

The processor 110 may include at least one of a central processing unit, a microprocessor, a graphics processing unit, an application processor (AP), application specific integrated circuits (ASICs), digital signal processors (DSPs), digital signal processing devices (DSPDs), programmable logic devices (PLDs), field programmable gate arrays (FPGAs), or AI-only processors designed with a hardware structure specialized for learning and processing of a neural processing unit or an AI model, but the disclosure is not limited thereto. As set forth above, each “processor” or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

When one or more instructions are executed by at least one processor 110 individually or collectively, the electronic device 1000 according to an embodiment of the disclosure may obtain an image prior to a current time point, based on a user input corresponding to a request for image modification while displaying an image. The electronic device 1000 may obtain a knowledge graph corresponding to the image prior to the current time point and a scenario corresponding to the image prior to the current time point through a first AI model, based on the obtained image prior to the current time point. The electronic device 1000 may obtain an image after the current time point through a second AI model, based on the knowledge graph corresponding to the image prior to the current time point, the scenario corresponding to the image prior to the current time point, and information corresponding to image modification, according to information corresponding to image modification related to the user input.

The electronic device 1000 according to an embodiment of the disclosure may obtain at least one of an object, text, or voice from the image prior to the current time point. The electronic device 1000 may obtain information corresponding to the image prior to the current time point, including the obtained at least one of the object, the text, or the voice. The electronic device 1000 may obtain the knowledge graph corresponding to the image prior to the current time point and the scenario corresponding to the image prior to the current time point through the first AI model, based on information corresponding to the image prior to the current time point.

The electronic device 1000 according to an embodiment of the disclosure may obtain an image corresponding to at least one entity included in the image prior to the current time point through the first AI model, based on information corresponding to the image prior to the current time point.

The electronic device 1000 according to an embodiment of the disclosure may obtain the updated knowledge graph from the knowledge graph corresponding to the image prior to the current time point, based on the user input corresponding to the modification of the information corresponding to at least one entity in the knowledge graph corresponding to the image prior to the current time point.

The electronic device 1000 according to an embodiment of the disclosure may obtain an image generation prompt based on the updated knowledge graph and the scenario corresponding to the image prior to the current time point. The electronic device 1000 may obtain an image after the current time point through the second AI model, based on the image generation prompt.

The electronic device 1000 according to an embodiment of the disclosure may obtain a changed current time point image, based on a user input corresponding to the modification of the image corresponding to at least one entity in the current time point image.

The electronic device 1000 according to an embodiment of the disclosure may generate the image generation prompt based on the updated knowledge graph and the scenario corresponding to the image prior to the current time point. The electronic device 1000 may obtain the image after the current time point through the second AI model, based on the image generation prompt and the changed current time point image.

The electronic device 1000 according to an embodiment of the disclosure may obtain a scenario corresponding to an original image after the current time point through a third AI model. The electronic device 1000 may obtain the image after the current time point, based on a similarity to the scenario corresponding to the original image after the current time point.

The electronic device 1000 according to an embodiment of the disclosure may obtain a first preliminary image after a current time point corresponding to a first time through the second AI model. The electronic device 1000 may calculate a first similarity between the scenario corresponding to the original image after the current time point corresponding to a first part and the obtained first preliminary image after the current time point. For example, the scenario corresponding to the original image after the current time point corresponding to the first part may be portion of the scenario corresponding to the original image after the current time point. When the first similarity is less than a threshold value, the electronic device 1000 may re-obtain the first preliminary image after the current time point corresponding to the first time through the second AI model. When the first similarity is greater than or equal to the threshold value, the electronic device 1000 may identify (or determine) the obtained first preliminary image after the current time point as a first image after the current time point corresponding to the first time.

The electronic device 1000 according to an embodiment of the disclosure may identify, as the first similarity, a maximum value among similarities between each of a plurality of sentences in the scenario corresponding to the original image after the current time point corresponding to the first part and the obtained first preliminary image after the current time point.

The electronic device 1000 according to an embodiment of the disclosure may obtain a second preliminary image after the current time point corresponding to a second time after the first time through the second AI model, based on the determination of the first image after the current time point. The electronic device 1000 may calculate a second similarity between the scenario corresponding to the original image after the current time point corresponding to a second part after the first part and the generated second preliminary image after the current time point. For example, the scenario corresponding to the original image after the current time point corresponding to the second part may be another portion of the scenario corresponding to the original image after the current time point, described later than the first part. The scenario corresponding to the original image after the current time point corresponding to the second part may include a scenario regarding the original image at a later time point than the scenario corresponding to the original image after the current time point corresponding to the first part. When the second similarity is less than a threshold value, the electronic device 1000 may re-obtain the second preliminary image after the current time point corresponding to the second time through the second AI model. When the second similarity is greater than or equal to the threshold value, the electronic device 1000 may identify (or determine) the obtained second preliminary image after the current time point as a second image after the current time point corresponding to the second time.

The electronic device 1000 may be any type of device that performs a function, including the processor 110 and the memory 120. The electronic device 1000 may be a stationary or portable device. For example, the electronic device 1000 may refer to a device including a display capable of displaying image content, video content, game content, graphic content, etc. The electronic device 1000 may output or display images or content received from a server device. The electronic device 1000 may include various types of electronic devices capable of receiving and outputting content, for example, TVs such as network TVs, smart TVs, Internet TVs, web TVs, or IPTVs, computers such as desktops, laptops, or tablets, other smart devices such as smart phones, cellular phones, game players, music players, video players, medical instruments, or home appliances, and the like. The electronic device 1000 may be referred to as a display device in that the electronic device 1000 receives and displays content, and may also be referred to as a content receiving device, a sink device, a computing device, etc. However, the disclosure is not limited thereto.

The block diagram of the electronic device 1000 illustrated in FIG. 3 is an example configuration. Each element of the block diagram may be integrated, added, or omitted according to the specifications of the electronic device 1000 that is actually implemented. For example, when necessary, two or more elements may be integrated into one element, or one element may be subdivided into two or more elements. In addition, the functions performed by each block are for describing the various embodiments of the disclosure, and specific operations or devices thereof are not intended to limit the scope of the disclosure.

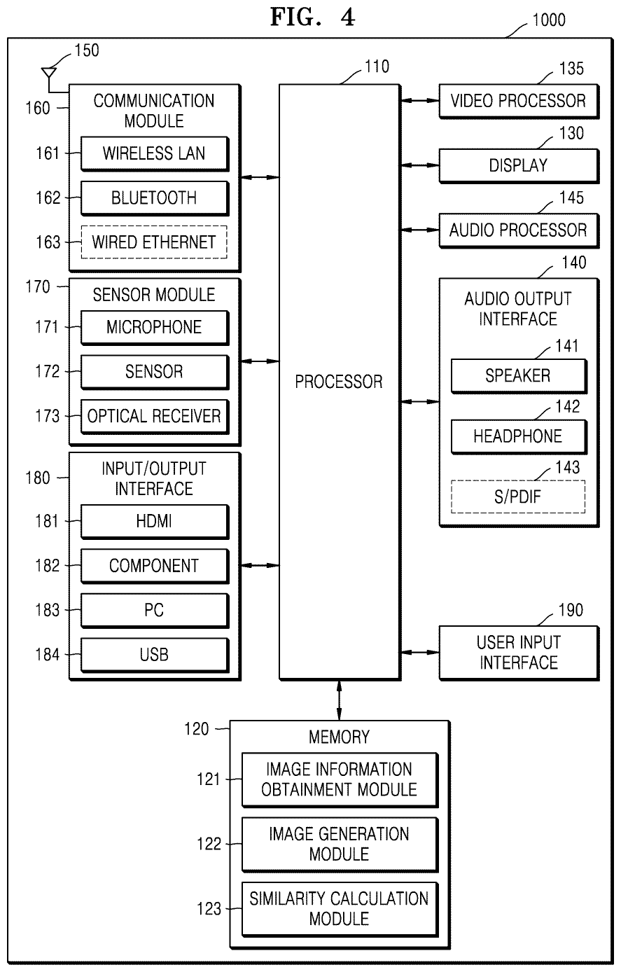

FIG. 4 is a block diagram illustrating an example configuration of the electronic device 1000 according to various embodiments.

Referring to FIG. 4, the electronic device 1000 according to an embodiment of the disclosure may include a processor (e.g., including processing circuitry) 110, memory 120, a tuner 150, a communication module (e.g., including communication circuitry) 160, a sensor module (e.g., including at least one sensor) 170, an input/output interface (e.g., including various circuitry) 180, a video processor (e.g., including various circuitry and/or executable program instructions) 135, a display 130, an audio processor (e.g., including various circuitry and/or executable program instructions) 145, an audio output interface (e.g., including circuitry) 140, and a user input interface (e.g., including circuitry) 190. However, all of the elements illustrated in FIG. 4 are not essential elements. The electronic device 1000 may be implemented with more elements than the elements illustrated in FIG. 4, or may be implemented with fewer elements than the elements illustrated in FIG. 4.

The memory 120 may store instructions, algorithms, data structures, program code, and application programs for processing and control by the processor 110, and may store data input to or output from the electronic device 1000. The memory 120 may include at least one of flash memory-type memory, hard disk-type memory, multimedia card micro-type memory, card-type memory (e.g., SD or XD memory), RAM, SRAM, ROM, EEPROM, PROM, mask ROM, flash ROM, hard disk drive (HDD), or solid state drive (SSD). The program (one or more instructions) or the application stored in memory 120 may be executed by the processor 110.

In an embodiment of the disclosure, the memory 120 may include an image information obtainment module 121, an image generation module 122, and a similarity calculation module 123. The “module” included in the memory 120 may refer, for example, to a unit that processes the function or operation performed by the processor 110, and may be implemented as software, such as instructions, algorithms, data structures, or program code.

The image information obtainment module 121 may include an appropriate logic, circuitry, interface, and/or code that may allow one or more AI models to be operated to generate, from an input image, information (e.g., a knowledge graph or a scenario) corresponding to the image.

The image generation module 122 may include an appropriate logic, circuitry, interface, and/or code that allows one or more AI models to be operated to generate a new image from information about an input image.

The similarity calculation module 123 may include an appropriate logic, circuitry, interface, and/or code that allows one or more AI models to be operated to calculate similarity between images and texts from information corresponding to an input image and a scenario.

The tuner 1150 may turn and select only a frequency of a channel to be received by the electronic device 1000 among radio wave components by amplifying, mixing, and/or resonating broadcast content received in a wired or wireless manner. The broadcast signal received through the tuner 150 may be separated into audio, video, and additional information (e.g., electronic program guide (EPG)). The separated audio, video, and additional information may be stored in the memory 120 under the control by the processor 110.

The tuner 150 may receive broadcast signals from various sources, such as terrestrial broadcasting, cable broadcasting, satellite broadcasting, or Internet broadcasting. The tuner 150 may also receive broadcast signals from sources, such as analog broadcasting or digital broadcasting.

The communication module 160 may include various communication circuitry and connect the electronic device 1000 to a peripheral device, an external device, a server, a display device, a remote control device, a mobile terminal, etc. under the control by the processor 110. The communication module 160 may include at least one communication module capable of performing wireless communication. For example, the communication module 160 may separately include a communication module that communicates with the server, a communication module that communicates with the display device, a communication module that communicates with the remote control device, and a communication module that communicates with the mobile terminal, or may include a single integrated module.

The communication module 160 may include at least one of a wireless local area network (LAN) module 161, a Bluetooth module 162, or a wired Ethernet 163 according to the performance and structure of the electronic device 1000. The Bluetooth module 162 may receive Bluetooth signals transmitted from the peripheral device in accordance with the Bluetooth communication standard. The Bluetooth module 162 may be a Bluetooth Low Energy (BLE) communication module and may receive BLE signals. The Bluetooth module 162 may continuously or temporarily scan the BLE signals so as to detect whether the BLE signals are received. The wireless LAN module 161 may transmit and receive Wi-Fi signals to and from the peripheral device in accordance with the Wi-Fi communication standard.

The sensor module 170 may include at least one sensor and sense a user's voice, a user's image, or a user's interaction, and may include a microphone 171, a sensor 172, and an optical receiver 173.

The microphone 171 may receive an audio signal including a noise or a user's uttered voice and may convert the received audio signal into an electrical signal and output the electrical signal to the processor 110.

The microphone 171 may be provided in the remote control device, such as a remote controller, a mobile terminal, or an AI speaker. For example, the mobile terminal may execute an application for remotely controlling the electronic device 1000. In this case, the microphone 171 provided in the remote control device may receive an audio signal including a noise or a user's uttered voice. The remote control device may convert the audio signal into a control signal and transmit the control signal to the electronic device 1000. The electronic device 1000 may receive the control signal from the remote control device through the communication module 160.

The sensor 172 may detect a user's image or a user's interaction, gesture, and touch and may include a distance sensor, an image sensor, a gesture sensor, an illumination sensor, and the like. The distance sensor may include various sensors that detect the distance between the electronic device 1000 and the user, such as an ultrasonic sensor, an infrared radiation (IR) sensor, or a time-of-flight (TOF) sensor. The distance sensor may detect the distance from the user and may transmit sensing data to the processor 110. The image sensor may capture a user's gesture through a camera or the like and transmit the captured gesture to the processor 110. The gesture sensor may detect a moving speed or direction through an acceleration sensor a gyro sensor. The illumination sensor may detect ambient illuminance.

The optical receiver 173 may receive an optical signal (including a control signal). The optical receiver 173 may receive an optical signal corresponding to a user input (e.g., touch, press, touch gesture, voice, or motion) from a control device, such as a remote controller or a mobile phone.

The input/output interface 180 may include various circuitry and receive video (e.g., dynamic image signals or still image signals), audio (e.g., voice signals or music signals), and additional information from the external device or the like under the control by the processor 110. The input/output interface 180 may include a port through which video and audio are output together, or may include a port through which video and audio are output separately.

The input/output interface 180 may include one of an high-definition multimedia interface (HDMI) port 181, a component jack 182, a PC port 183, and a universal serial bus (USB) 184. The input/output interface 180 may include a combination of the HDMI port 181, the component jack 182, the PC port 183, and the USB port 184. Furthermore, the input/output interface 180 may include one of a display port (DP), a Thunderbolt port, a video graphics array (VGA) port, an RGB port, a D-subminiature (D-sub), and a digital visual interface (DVI).

When the electronic device 1000 corresponds to a content providing device such as a set-top box, the input/output interface 180 may output video, audio, and additional information to the display device under the control by the processor 110.

In an embodiment of the disclosure, image data and voice data may be transmitted through separate ports of the input/output interface 180 and may be stored as separate tracks in the electronic device 1000. For example, the image data may be transmitted through a port such as VGA or DVI, and the voice data may be transmitted through a separate port. The image data and the voice data may be transmitted as a single stream through HDMI, DP, Thunderbolt, etc., and may be stored as separate tracks in the electronic device 1000.

The video processor 135 may include various circuitry and/or executable program instructions and process image data to be displayed by the display 130 and may perform, on the image data, various image processing operations, such as decoding, rendering, scaling, noise reduction, frame rate conversion, and resolution conversion.

The display 130 may output, on a screen, content received from a broadcasting station or an external device, such as an external server or external storage medium. The content is a media signal and may include video signals, images, text signals, etc. The audio processor 145 may include various circuitry and/or executable program instructions and perform processing on audio data. The audio processor 145 may perform a variety of processing, such as decoding, amplification, or noise reduction, on the audio data.

The audio output interface 140 may include various circuitry and output audio included in content received through the tuner 150, audio input through the communication module 160 or the input/output interface 180, and audio stored in the memory 120 under the control by the processor 110. The audio output interface 140 may include at least one of a speaker 141, a headphone 142, or a Sony/Philips digital interface (S/PDIF) 143.

The user input interface 190 may include various circuitry and receive a user input for controlling the electronic device 1000. The user input interface 190 may include various types of user input devices, including a touch panel that detects the user's touch, a button that receives the user's push operation, a wheel that receives the user's rotating operation, a keyboard, and a dome switch, a microphone for voice recognition, and a motion detection sensor that senses a motion, but the disclosure is not limited thereto. When the remote controller (e.g., the remote control device) or other mobile terminal controls the electronic device 1000, the user input interface 190 may receive a control signal received from the remote control device.

Hereinafter, an operation in which the electronic device 1000 obtains an image prior to a current time point and obtains a knowledge graph and a scenario from the image prior to the current time point is described in greater detail below with reference to FIGS. 5 to 8.

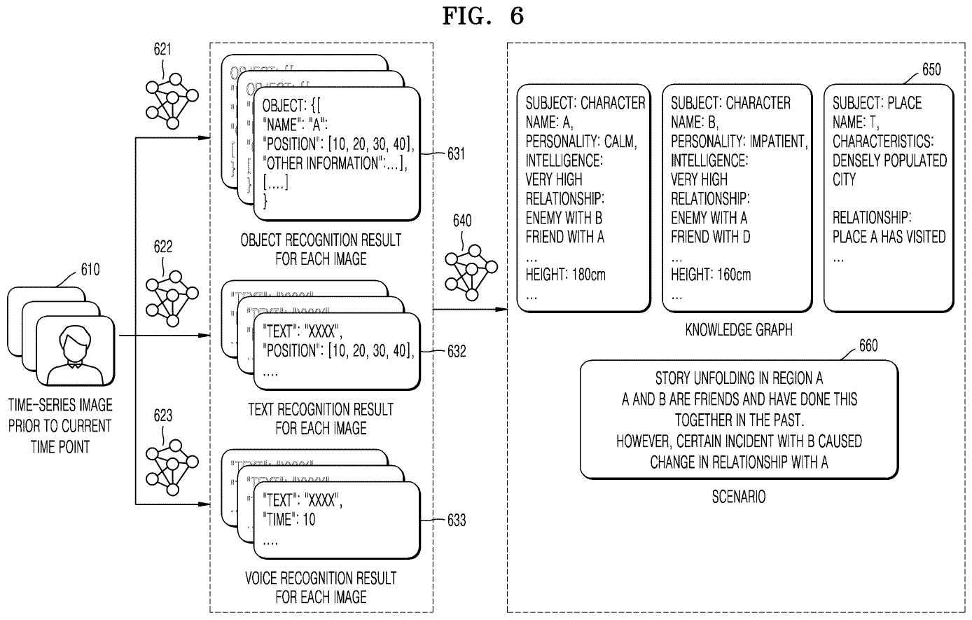

FIG. 5 is a flowchart illustrating an example method, performed by the electronic device 1000, of obtaining information about an image prior to a current time point, according to various embodiments. FIG. 6 is a diagram illustrating an example method, performed by the electronic device 1000, of obtaining information about an image prior to a current time point, according to various embodiments.

Operations S510, S520 and S530 illustrated in FIG. 5 are operations that may embody operation S220 of FIG. 2. Operation S510 illustrated in FIG. 5 may be performed after operation S210 illustrated in FIG. 2. Operation S230 illustrated in FIG. 2 may be performed after operation S530 illustrated in FIG. 5.

In operation S510 of FIG. 5, the electronic device 1000 according to an embodiment of the disclosure may obtain at least one of an object, text, or voice from the image 610 prior to the current time point. For example, the electronic device 1000 may recognize at least one of an object, text, or voice from the image 610 prior to the current time point through at least one AI model.

Referring to FIGS. 5 and 6, in an embodiment of the disclosure, the electronic device 1000 may recognize an object from the image 610 prior to the current time point through a fourth AI model 621. The fourth AI model 621 may receive time-series images 610 prior to the current time point as input and may output an object recognition result 631 for each of the time-series images 610 prior to the current time point. For example, the object recognition result 631 for each of the time-series images 610 prior to the current time point may include an index of the object, position coordinates of the object, etc.

In the disclosure, the “object” may refer to a particular object within an image (or video) and may be classified by class. For example, people, animals, objects, natural objects, buildings, etc. in the image (or video) may be the subject of the object. In an embodiment of the disclosure, the object may include a particular area of a particular object. For example, the object may include a human face.

In an embodiment of the disclosure, the electronic device 1000 may recognize text from the image 610 prior to the current time point through a fifth AI model 622. The fifth AI model 622 may receive the time-series images 610 prior to the current time point as input and may output a text recognition result 632 for each of the time-series images 610 prior to the current time point. For example, the text recognition result 632 for each of the time-series images 610 prior to the current time point may include contents of the text, position coordinates of the text, etc.

In an embodiment of the disclosure, the electronic device 1000 may recognize voice from the image 610 prior to the current time point through a sixth AI model 623. The sixth AI model 623 may receive the time-series images 610 prior to the current time point as input and may output a voice recognition result 633 for each of the time-series images 610 prior to the current time point. For example, the voice recognition result 633 for each of the time-series image 610 prior to the current time point may include contents of text recognized from the voice, the time at which the voice is output (or the time of utterance in the image), etc.

For example, each of the fourth to sixth AI models 621, 622, and 623 may be a transformer-based model or a convolution-based model (or a CNN). For example, each of the fourth to sixth AI models 621, 622, and 623 may be a multimodal model. In the disclosure, the “multimodal model” may be a neural network model that simultaneously processes multiple types of modalities (e.g., text data, image data, voice data, video data, etc.) and learns relationships therebetween. However, the disclosure is not limited thereto.

In operation S520 of FIG. 5, the electronic device 1000 according to an embodiment of the disclosure may obtain information corresponding to the image prior to the current time point in which the obtained at least one of the object, the text, or the voice is collected.

Referring to FIGS. 5 and 6, in an embodiment of the disclosure, the electronic device 1000 may collect the object recognition result 631 for each of the time-series image 610 prior to the current time point obtained through the fourth AI model 621, the text recognition result 632 for each of the time-series image 610 prior to the current time point obtained through the fifth AI model 622, and the voice recognition result 633 for each of the time-series image 610 prior to the current time point obtained through the sixth AI model 623. For example, the electronic device 1000 may list the collated results as follows.

```
[
  {
    ″image number″: 1,
    ″object information″: [
      ″character A″
    ],
    ″text information″: [
        {
        ″text″: ″XXXX″
        ″position″ : [
          10,
          100,
          20,
          200
          ]
        }
    ],
    ″subtitle information″: {
      ″subtitle section″: [
        1,
        50,
      ],
      ″subtitle text″: [
        ″XXXX″
      ]
    }
  }
]
```

The collected information described in the above example may include a unique frame number (or index) sequentially assigned according to a playback time, and object information, text information, and voice information (or subtitle information) recognized from the image corresponding to the frame number (or index). The voice information may be provided in the form of text in which the time point and contents of utterance within the image are structured.

In operation S530 of FIG. 5, the electronic device 1000 may obtain a knowledge graph 650 corresponding to the image prior to the current time point and a scenario 660 corresponding to the image prior to the current time point through a first AI model 640, based on information corresponding to the image prior to the current time point.

In an embodiment of the disclosure, the first AI model 640 may receive the information corresponding to the image prior to the current time point collected in operation S520 and the time-series image 610 prior to the current time point, and may generate the knowledge graph 650 corresponding to the image prior to the current time point and the scenario 660 corresponding to the image prior to the current time point. In an embodiment of the disclosure, the first AI model 640 may receive both the image and the text as input and output the text. However, the disclosure is not limited thereto, and the first AI model 640 may output both the text and the image.

In an embodiment of the disclosure, the knowledge graph 650 corresponding to the image prior to the current time point may include information about all entities, such as characters and backgrounds, which are recognized from the image 610 prior to the current time point. In the disclosure, the entity may be referred to as an entity that represents a meaningful unit that is recognizable in the image. For example, the entity may include characters, objects, backgrounds, etc. that are recognizable in the image. For example, when the entity is a character, the knowledge graph 650 for the image prior to the current time point may include information about a name, personality, intelligence, relationship with other characters, and height of the character. For example, when the entity is a place, the knowledge graph 650 for the image prior to the current time point may include information about a name of the place, characteristics of the place, and relationship with the character.

In an embodiment of the disclosure, the scenario 660 corresponding to the image prior to the current time point may include a summarized plot from the initial time point of the time-series image prior to the current time point to the current time point. For example, the electronic device 1000 may recognize an object, a motion of the object, a voice of the object, etc. from the image prior to the current time point which is input through the first AI model 640, may infer an event, relationship between objects (e.g., characters), etc. therefrom, and may generate a scenario based on a preset scenario template. For example, the scenario 660 corresponding to the image prior to the current time point may include information about a place where an event occurs, such as “a story unfolding in region A,” information about a relationship between characters, such as “A and B are friends and have done this together in the past,” and information about an event that occurred, such as “however, a certain incident with B caused a change in relationship with A.”

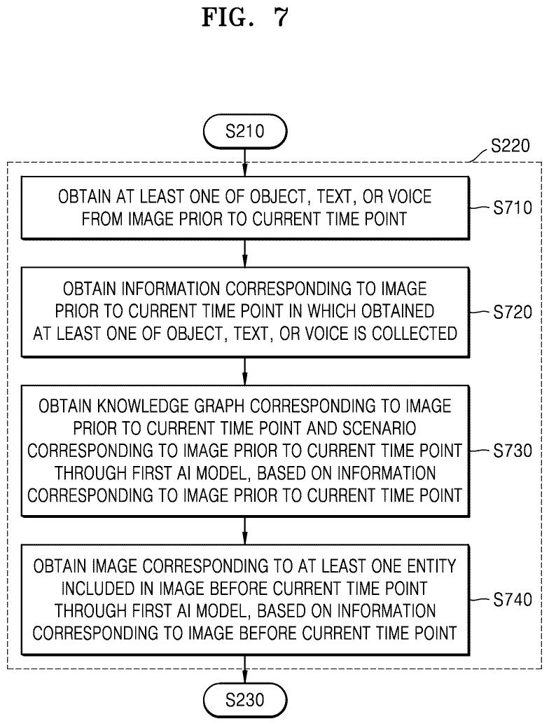

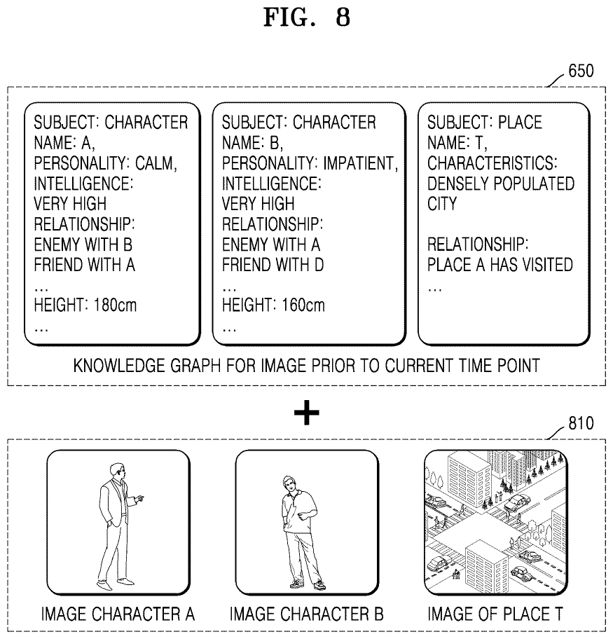

FIG. 7 is a flowchart illustrating an example method, performed by the electronic device 1000, of obtaining information about an image prior to a current time point, according to various embodiments. FIG. 8 is a diagram illustrating an example method, performed by the electronic device 1000, of obtaining information about an image prior to a current time point, according to an embodiment of the disclosure.

Operations S710 to S740 illustrated in FIG. 7 are operations that may embody operation S220 of FIG. 2. Operation S710 illustrated in FIG. 7 may be performed after operation S210 illustrated in FIG. 2. Operation S230 illustrated in FIG. 2 may be performed after operation S740 illustrated in FIG. 7. The same description as described with reference to FIG. 5 is applied to operations S710, S720, and S730 illustrated in FIG. 7, and therefore, a detailed description thereof may not be repeated here.

In operation S740 of FIG. 7, the electronic device 1000 may obtain an image 810 corresponding to at least one entity included in the image prior to the current time point through the first AI model (see 640 of FIG. 6), based on information corresponding to the image prior to the current time point. In other words, in an embodiment of the disclosure, the electronic device 1000 may output not only data in a text format, such as the knowledge graph (see 650 of FIG. 6) corresponding to the image prior to the current time point and the scenario (see 660 of FIG. 6) corresponding to the image prior to the current time point, but also data in an image format.

Referring to FIG. 8, the image 810 corresponding to at least one entity may include a representative image of an object such as a character, a background, or a position, which is recognized from the image prior to the current time point. For example, the electronic device 1000 may provide, through the first AI model (see 640 of FIG. 6), not only text information about “character A,” “character B,” “place T,” etc., but also a representative image of “character A,” a representative image of “character B,” a representative image of “place T,” etc., which appears in the image prior to the current time point. For example, the image of “character A” may be provided as an image of a person who is taller than “character B.” For example, the image of “place T” may be provided as an image of a city with many people and tall buildings.

However, the disclosure is not limited thereto, and the electronic device 1000 according to an embodiment of the disclosure may obtain an image of at least one entity appearing in the image prior to the current time point through an external server or a web server.

Hereinafter, an operation in which the electronic device 1000 obtains user input information about image modification is described in greater detail with reference to FIGS. 9 to 12.

FIG. 9 is a flowchart illustrating an example method, performed by the electronic device 1000, of changing information about a current image, according to various embodiments. FIG. 10 is a diagram illustrating an example method, performed by the electronic device 1000, of changing information about a current image, according to various embodiments.

Operation S910 of FIG. 9 is operation that may embody operation S230 of FIG. 2. Operation S910 illustrated in FIG. 9 may be performed after operation S220 illustrated in FIG. 2.

In operation S910 of FIG. 9, the electronic device 1000 according to an embodiment of the disclosure may obtain a changed current time point image 1030, based on a user input corresponding to modification of the image corresponding to at least one entity in a current time point image 1010. For example, the electronic device 1000 may provide a user interface that allows a user to request the modification of the image corresponding to at least one entity in the current time point image 1010 and to input information about the modification, and may receive a user input of requesting the modification of the image corresponding to at least one entity in the current time point image 1010 through the user interface.

Referring to FIGS. 9 and 10, the electronic device 1000 may provide a still image 1010 at the current time point. In other words, the electronic device 1000 may provide a still image at the time point when the user inputs a request for image modification while displaying the image.

In an embodiment of the disclosure, the electronic device 1000 may provide a user interface that allows the user to change the outer appearance of at least one entity in the still image 1010 at the current time point. For example, the electronic device 1000 may provide a user interface that allows a user to select at least one entity in the still image 1010 at the current time point and to change the outer appearance of the selected entity 1020. For example, the electronic device 1000 may provide candidate images of the outer appearance that may be changed in the entity 1020 selected through the user interface and may allow the user to select one candidate image from among the candidate images. For example, the electronic device 1000 may allow the user to directly draw an outer appearance that the user wishes to add or modify through the user interface.

For example, the electronic device 1000 may receive a user input of adding a “mustache” to character A in the still image 1010 at the current time point. Accordingly, the electronic device 1000 may obtain a changed current time point image 1030 in which character A with the mustache added thereto is reflected. However, the disclosure is not limited thereto. For example, the electronic device 1000 may obtain the changed current time point image 1030 in which the outer appearance of character A is completely modified according to the user input of changing the actor of character A. For example, the electronic device 1000 may obtain the changed current time point image 1030 in which the background is completely modified according to the user input of changing the place.

FIG. 11 is a flowchart illustrating an example method, performed by the electronic device 1000, of changing information about a current image, according to various embodiments. FIG. 12 is a diagram illustrating an example method, performed by the electronic device 1000, of changing information about a current image, according to various embodiments.

Operation S1110 of FIG. 11 is operation that may embody operation S230 of FIG. 2. Operation S1110 illustrated in FIG. 11 may be performed after operation S220 illustrated in FIG. 2.

In operation S1110 of FIG. 11, the electronic device 1000 according to an embodiment of the disclosure may obtain an updated knowledge graph 1230 from a knowledge graph 1210 corresponding to an image prior to the current time point, based on a user input corresponding to modification of information corresponding to at least one entity in the knowledge graph corresponding to the image prior to the current time point. For example, the electronic device 1000 may provide a user interface that allows a user to request the modification of the image corresponding to at least one entity included in the knowledge graph corresponding to the image prior to the current time point and to input information about the modification, and may receive a user input of requesting the modification of the image corresponding to at least one entity included in the knowledge graph corresponding to the image prior to the current time point through the user interface.

Referring to FIGS. 11 and 12, the electronic device 1000 according to an embodiment of the disclosure may receive a user input 1220 of requesting modification of at least one piece of entity information. For example, the electronic device 1000 may receive the user input 1220 of requesting not only external modifications in the image but also modifications that are not externally visible, such as changes in character's personality, economic situation, or intelligence level, changes in relationships between characters, and the like.

In an embodiment of the disclosure, the electronic device 1000 may receive modification contents of at least one piece of entity information in the form of text or voice. In an embodiment of the disclosure, the electronic device 1000 may provide a user interface that allows the user to select an entity to be modified from among entities (e.g., characters, places, etc.) included in the knowledge graph. In an embodiment of the disclosure, when the entity to be modified is selected, the electronic device 1000 may provide a user interface of providing various examples of modification contents of the selected entity and allowing the user to select some of the various examples.

For example, the electronic device 1000 may receive the user input 1220 indicating that “From now on, A is a strong narcissistic person.” The electronic device 1000 may identify that the “personality” of “character A” has changed, and may modify information about the “personality” of “character A” in the knowledge graph 1210 for the image prior to the current time point from “calm” to “strong narcissistic.” In other words, the electronic device 1000 may obtain the updated knowledge graph 1230 in which the modification of the personality of “character A” in the knowledge graph 1210 corresponding to the image prior to the current time point is reflected.

According to an embodiment of the disclosure, because the electronic device 1000 receives the user input 1220 of modifying information about at least one entity in the image prior to the current time point, the electronic device 1000 may enable modification of various types or intangible objects as well as external modifications in the image.

Although the operation in which the electronic device 1000 obtains user input information corresponding to image modification has been described with reference to FIGS. 9 to 12, both operation S910 of FIG. 9 and operation S1110 of FIG. 11 may be performed, or one of operation S910 of FIG. 9 and operation S1110 of FIG. 11 may be performed. For example, when both operation S910 of FIG. 9 and operation S1110 of FIG. 11 are performed, the electronic device 1000 may obtain both the changed current time point image 1030 and the updated knowledge graph 1230. When only operation S910 of FIG. 9 is performed, the electronic device 1000 may obtain only the changed current time point image 1030. When the change in the current time point image is not the change in the information of the knowledge graph corresponding to the image prior to the current time point, the knowledge graph corresponding to the image prior to the current time point may be equally maintained. When only operation S1110 of FIG. 11 is performed, the electronic device 1000 may obtain only the updated knowledge graph 1230.

Hereinafter, an operation of generating a new image after a current time point, based on various pieces of information obtained while performing operations S210 and S220, is described in greater detail with reference to FIGS. 13 to 18.

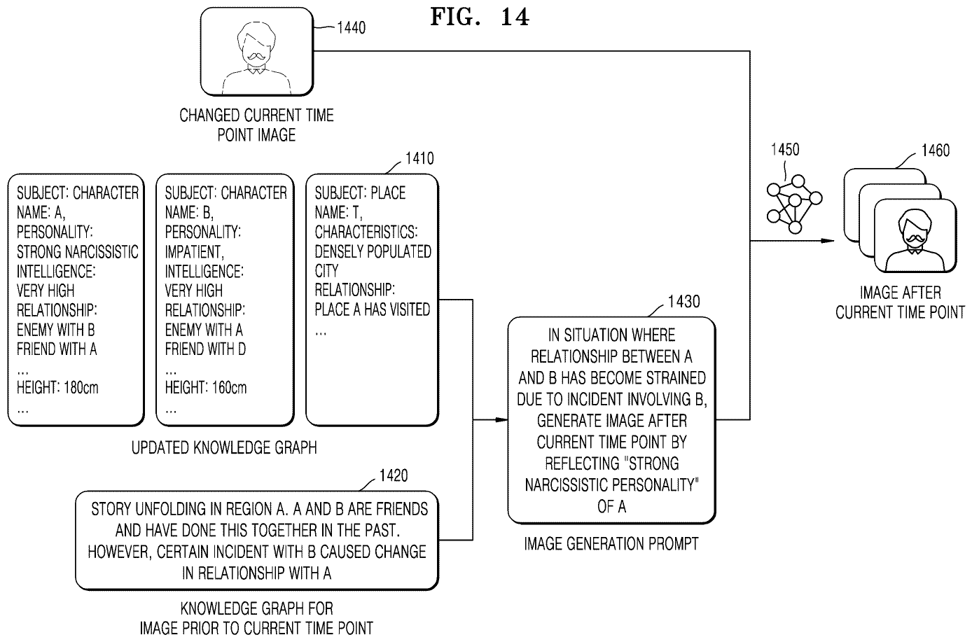

FIG. 13 is a flowchart illustrating an example method, performed by the electronic device 1000, of generating a new image after a current time point, according to various embodiments. FIG. 14 is a diagram illustrating an example method, performed by the electronic device 1000, of generating a new image after a current time point, according to various embodiments.

Operation S1310 of FIG. 13 is operation that may embody operation S230 of FIG. 2. Operation S1310 illustrated in FIG. 13 may be performed after operation S220 illustrated in FIG. 2.

In operation S1310 of FIG. 13, the electronic device 1000 according to an embodiment of the disclosure may obtain an image generation prompt 1430, based on a scenario 1420 corresponding to an image prior to a current time point and an updated knowledge graph 1410. The image generation prompt 1430 may be generated based on the scenario 1420 corresponding to the image prior to the current time point and the updated knowledge graph 1410.

In the disclosure, the “prompt” may be used as input information necessary for a generative model to perform a task. The prompt may include natural language text. In the natural language text, the prompt may include various pieces of information, for example, tasks to be performed by the generative model and components available for the generative model to perform the tasks, such as context, intent, constraints, and examples. In an embodiment of the disclosure, the electronic device 1000 may process the natural language text using a natural language processing (NLP) model. In the disclosure, the prompt may be replaced with an input, a command, a directive, an input phrase, a starting sentence, a task query, a trigger sentence, etc.

In the disclosure, the prompt may include a multimedia prompt that integrates various types of media elements, including text, images, voice, video, music, animation, etc. The multimedia prompt may be a combination of different types of media elements in the same situation.

In an embodiment of the disclosure, the electronic device 1000 may generate the image generation prompt 1430, based on the updated knowledge graph 1410 and the scenario 1420 corresponding to the image prior to the current time point.

Referring to FIGS. 13 and 14, the electronic device 1000 may generate the image generation prompt 1430 for generating an image after the current time point, based on the scenario 1420 corresponding to the image prior to the current time point, which is obtained in operation S530 of FIG. 5, and the updated knowledge graph 1410 obtained in operation S1110 of FIG. 11. According to an embodiment of the disclosure, because the image generation prompt 1430 is generated based on the updated knowledge graph 1410 and the scenario 1420 corresponding to the image prior to the current time point, the electronic device 1000 may generate a scenario after the current time point in which information about an entity updated through a user input is reflected.

For example, the electronic device 1000 may generate the image generation prompt 1430 for generating the image after the current time point, based on the scenario 1420 in the image prior to the current time point, which indicates that “A and B are friends and used to do things together, but the relationship between A and B has become strained due to a certain incident involving B,” and the updated knowledge graph 1410 according to “the personality of character A changed from calm to strong narcissistic.” For example, the electronic device 1000 may generate the image generation prompt 1430, such as “in a situation where the relationship between A and B has become strained due to an incident involving B, generate an image after a current time point by reflecting the ‘strong narcissistic personality’ of A.”

According to an embodiment of the disclosure, the electronic device 1000 may use a script writing tool to generate the image generation prompt 1430 for generating an image written suitably for according to a preset template, based on the updated knowledge graph 1410 and the scenario 1420 in the image prior to the current time point. FIG. 14 illustrates an example in which the image generation prompt 1430 includes text, but the disclosure is not limited thereto, and the image generation prompt 1430 may include text and images. According to an embodiment of the disclosure, the electronic device 1000 may generate the image generation prompt 1430 through a generative model.

In operation S1320 of FIG. 13, the electronic device 1000 may obtain an image 1460 after the current time point through the second AI model 1450, based on the image generation prompt 1430 and a changed current time point image 1440. For example, the image 1460 after the current time point may be an image generated through the second AI model 1450, based on the image generation prompt 1430 and the changed current time point image 1440. For example, the image 1460 after the current time point, which is obtained through the second AI model 1450, may be a new image that is different from the original image after the current time point. For example, the electronic device 1000 may obtain the image 1460 after the current time point through the second AI model 1450, based on the image generation prompt 1430 and the changed current time point image 1440.

Referring to FIGS. 13 and 14, the electronic device 1000 may generate the image 1460 after the current time point by inputting the image generation prompt 1430 generated in operation S1310 and the changed current time point image 1440 obtained in operation S910 to the second AI model 1450.

The second AI model 1450 may perform an algorithm to generate a new image based on an input image and an input prompt. The second AI model 1450 may be an AI model pre-trained to generate a new image after the current time point, based on information about the input image and the input prompt. For example, the second AI model 1450 may generate a new scenario for the image after the current time point, based on the image generation prompt 1430. The second AI model 1450 may generate the image 1460 after the current time point, based on the generated new scenario and the changed current time point image. Accordingly, when generating the image 1460 after the current time point, the electronic device 1000 may take into account information about image modification after the current time point, which is input by the user. Therefore, the electronic device 1000 may generate a user-customized image.

FIG. 14 illustrates an example in which both the user input of modifying the current time point image and the user input of modifying information about the entity are input, but when the user input of modifying the current time point image is not received, the electronic device 1000 may receive the image generation prompt as input and may generate the image after the current time point, based on the image generation prompt.

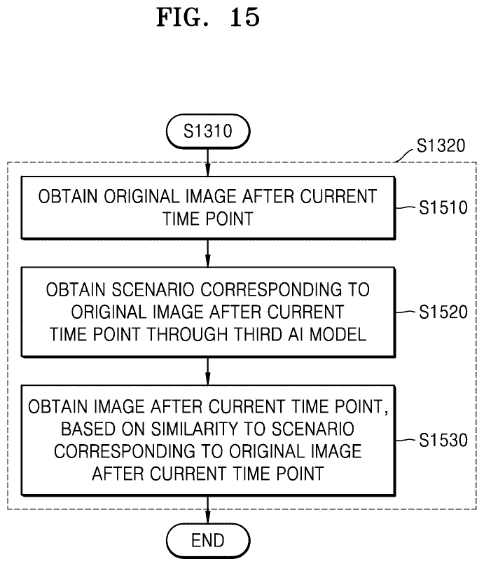

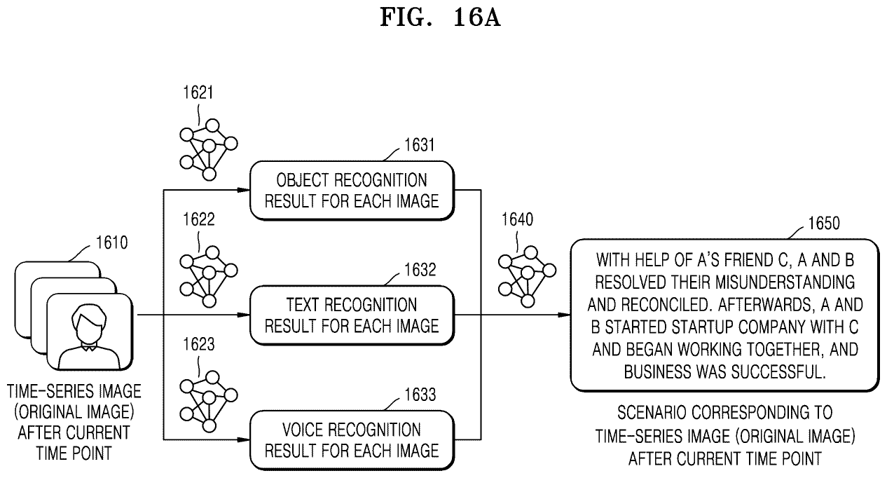

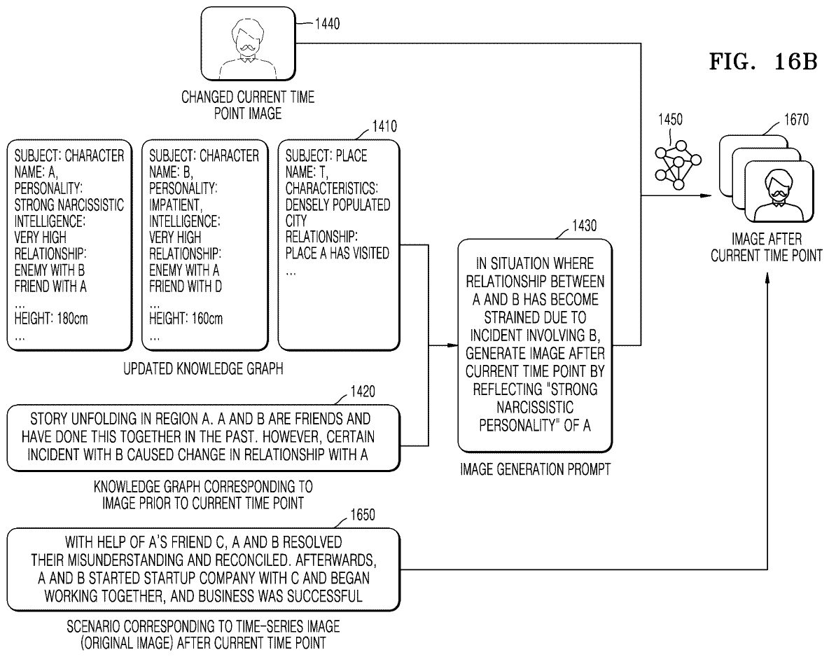

FIG. 15 is a flowchart illustrating an example method, performed by the electronic device 1000, of generating a new image after a current time point, according to various embodiments. FIG. 16A is a diagram illustrating an example method, performed by the electronic device 1000, of obtaining information about an original image after a current time point, according to various embodiments. FIG. 16B is a diagram illustrating an example method, performed by the electronic device 1000, of generating a new image after a current time point, according to various embodiments.

Operations S1510 to S1530 illustrated in FIG. 15 are operations that may embody operation S1320 of FIG. 13. Operation S1510 illustrated in FIG. 15 may be performed after operation S1310 illustrated in FIG. 13.

In operation S1510 of FIG. 15, the electronic device 1000 according to an embodiment of the disclosure may obtain an original image 1610 after a current time point.

The electronic device 1000 according to an embodiment of the disclosure may provide content received from an external server or an external device. In an embodiment of the disclosure, the electronic device 1000 may receive an entire image corresponding to particular content from the external server or the external device. In this case, unlike when receiving live content transmitted in real time through a broadcasting station or an online streaming platform, the electronic device 1000 may obtain not only an image prior to the current time point but also the original image 1610 after the current time point.

In operation S1520 of FIG. 15, the electronic device 1000 may obtain a scenario 1650 corresponding to the original image after the current time point through a third AI model 1640. The operation of obtaining the scenario 1650 corresponding to the original image after the current time point, based on the original image 1610 after the current time point, may be performed similarly to the operation of obtaining the scenario for the image prior to the current time point, based on the image prior to the current time point, which has been described above with reference to FIGS. 5 and 6.

Referring to FIGS. 15 and 16A, in an embodiment of the disclosure, the electronic device 1000 may obtain at least one of an object, text, or voice from the original image 1610 prior to the current time point.

For example, the electronic device 1000 may recognize an object in the original image 1610 after the current time point through a seventh AI model 1621. The seventh AI model 1621 may receive time-series images 1610 after the current time point as input and may output an object recognition result 1631 for each of the time-series images 1610 after the current time point. For example, the object recognition result 1631 for each of the time-series images 1610 after the current time point may include an index of the object, position coordinates of the object, etc.

For example, the electronic device 1000 may recognize text in the original image 1610 after the current time point through an eighth AI model 1622. The eighth AI model 1622 may receive the time-series images 1610 after the current time point as input and may output a text recognition result 1632 for each of the time-series images 1610 after the current time point. For example, the text recognition result 1632 for each of the time-series images 1610 after the current time point may include contents of the text, position coordinates of the text, etc.

For example, the electronic device 1000 may recognize an object in the original image 1610 after the current time point through a ninth AI model 1623. The ninth AI model 1623 may receive the time-series images 1610 after the current time point as input and may output a voice recognition result 1633 for each of the time-series images 1610 after the current time point. For example, the voice recognition result 1633 for each of the time-series image 610 after the current time point may include contents of text recognized from the voice, the time at which the voice is output (or the time of utterance in the image), etc.

For example, each of the seventh to ninth AI models 1621, 1622, and 1623 may be a transformer-based model or a convolution-based model (or a CNN). For example, each of the seventh to ninth AI models 1621, 1622, and 1623 may be a multimodal model. In the disclosure, the “multimodal model” may be a neural network model that simultaneously processes multiple types of modalities (e.g., text data, image data, voice data, video data, etc.) and learns relationships therebetween. However, the disclosure is not limited thereto. The seventh to ninth AI models 1621, 1622, and 1623 may be respectively the same as the fourth to sixth AI models described above with reference to FIG. 6. In other words, the electronic device 1000 may recognize an object, text, or voice in the image prior to the current time point and the image after the current time point through the same AI model.

In an embodiment of the disclosure, the electronic device 1000 may obtain information corresponding to the image after the current time point in which at least one of the recognized object, text, or voice is collected. For example, the electronic device 1000 may collect the object recognition result 1631 for each of the time-series image 1610 after the current time point, which is obtained through the seventh AI model 1621, the text recognition result 1632 for each of the time-series image 1610 after the current time point, which is obtained through the eighth AI model 1622, and the voice recognition result 1633 for each of the time-series image 1610 after the current time point, which is obtained through the ninth AI model 1623. For example, the electronic device 1000 may list the collected results as items, such as “image number,” “object information,” “text information,” and “subtitle information.”

In an embodiment of the disclosure, the electronic device 1000 may obtain the scenario 1650 corresponding to the original image after the current time point through the third AI model 1640, based on information corresponding to the original image 1610 after the current time point. The third AI model 1640 may receive information corresponding to the original image after the current time point and the original image after the current time point as input, and may generate the scenario 1650 corresponding to the original image after the current time point. The third AI model 1640 may be the same as the first AI model described above with reference to FIG. 6. In other words, the electronic device 1000 may generate a scenario corresponding to the image prior to the current time point and the original image after the current time point through the same AI model.

In an embodiment of the disclosure, the scenario corresponding to the original image after the current time point may include a summarized plot from the current time point to the last time point of the image. For example, the electronic device 1000 may recognize an object, a motion of the object, a voice of the object, etc. from the image after the current time point which is input through the third AI model 1640, may infer an event, relationship between objects (e.g., characters), etc. therefrom, and may generate a scenario based on a preset scenario template. For example, the scenario 1650 corresponding to the original image after the current time point may include information about relationships between characters, such as “With the help of A's friend C, A and B resolved their misunderstanding and reconciled,” or information about events that occurred, such as “Afterwards, A and B started a startup company with C and began working together, and the business was successful.”

In operation S1530 of FIG. 15, the electronic device 1000 may generate a new image 1672 after the current time point, based on a similarity to the scenario 1650 for the original image after the current time point.

Referring to FIGS. 15 and 16B, in an embodiment of the disclosure, the electronic device 1000 may generate an image 1670 after the current time point, and may calculate a similarity between the generated image 1670 and the scenario 1650 corresponding to the original image after the current time point. When the similarity between the generated image 1670 and the scenario 1650 corresponding to the original image after the current time point does not satisfy a preset threshold, the electronic device 1000 may re-generate a new image until the similarity satisfies the preset threshold. Accordingly, the electronic device 1000 may adjust the similarity to the original image when generating the new image 1670 after the current time point, and may generate a natural image by reducing disparity between the image prior to the current time point and the generated image 1670 after the current time point.

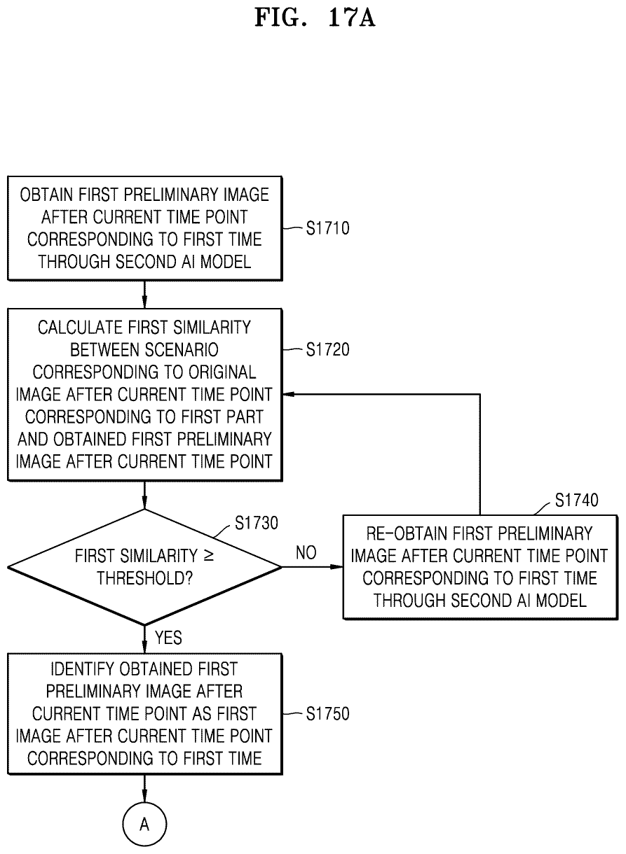

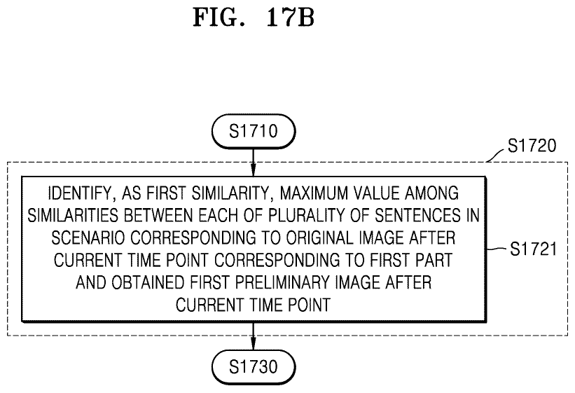

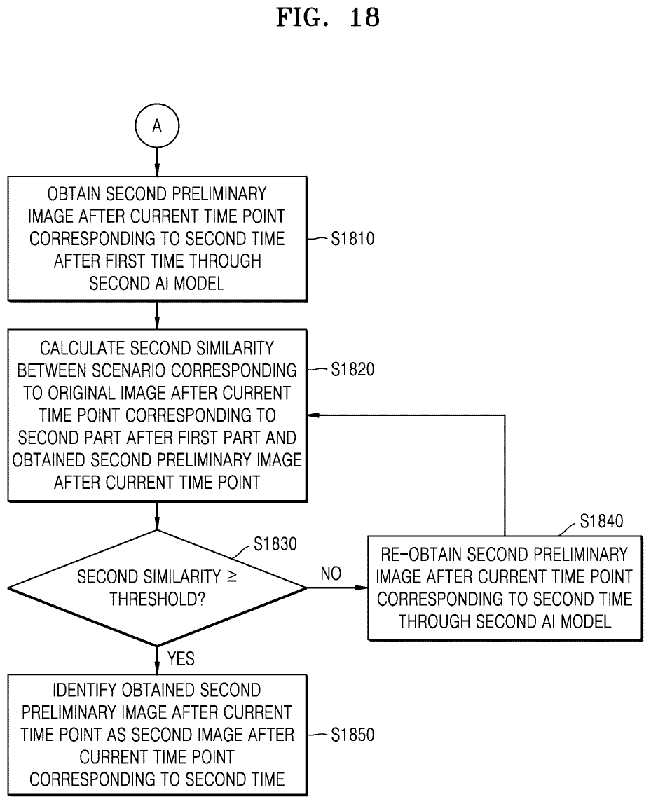

Hereinafter, the operation of calculating the similarity between the generated image and the scenario corresponding to the original image after the current time point is described in greater detail with reference to FIGS. 17A to 18.

FIG. 17A is a flowchart illustrating an example method, performed by the electronic device 1000, of calculating and verifying a similarity between a generated image and a scenario for an original image, according to various embodiments. FIG. 17B is a flowchart illustrating an example method, performed by the electronic device 1000, of calculating and verifying a similarity between a generated image and a scenario for an original image, according to various embodiments. FIG. 18 is a flowchart illustrating an example method, performed by the electronic device 1000, of calculating and verifying a similarity between a generated image and a scenario for an original image, according to various embodiments.

Operations S1710 to S1750 illustrated in FIG. 17A are operations that may embody operation S1530 of FIG. 15. Operation S1721 of FIG. 17B is operation that may embody operation S1720 of FIG. 17. Operations S1810 to S1850 illustrated in FIG. 18 are operations that may embody operation S1530 of FIG. 15. Operation S1810 of FIG. 18 may be performed after operation S1750 of FIG. 17A.

In operation S1710 of FIG. 17A, the electronic device 1000 according to an embodiment of the disclosure may obtain a first preliminary image after a current time point corresponding to a first time through the second AI model (see 1450 of FIG. 16B). For example, the electronic device 1000 may generate the first preliminary image after the current time point corresponding to the first time through the second AI model (see 1450 of FIG. 16B).

In operation S1720 of FIG. 17A, the electronic device 1000 may calculate a first similarity between the scenario corresponding to the original image after the current time point corresponding to the first part and the obtained first preliminary image after the current time point.

In operation S1730 of FIG. 17A, the electronic device 1000 may identify whether the calculated first similarity is greater than or equal to a threshold. When it is identified in operation S1730 that the first similarity is less than the threshold (“No” in operation S1730), the electronic device 1000 may proceed to operation S1740 to re-obtain the first preliminary image after the current time point corresponding to the first time through the second AI model. For example, when it is identified that the calculated first similarity is less than the threshold, the electronic device 1000 may re-generate the first preliminary image after the current time point corresponding to the first time through the second AI model.

When it is identified in operation S1730 that the first similarity is greater than or equal to the threshold (“Yes” in operation S1730), the electronic device 1000 may proceed to operation S1750 to identify the obtained first preliminary image after the current time point as the first image after the current time point corresponding to the first time. For example, when it is identified that the calculated first similarity is greater than or equal to the threshold, the electronic device 1000 may determine the first preliminary image, which is the reference for the calculated first similarity, as the first image after the current time point corresponding to the first time. The electronic device 1000 according to an embodiment of the disclosure may obtain the image after the current time point until the similarity to the scenario corresponding to the original image satisfies a preset level or higher. Accordingly, the electronic device 1000 may obtain a natural image as a whole by obtaining the new image after the current time point with reduced disparity from the image prior to the current time point. For example, when it is identified that the calculated first similarity is greater than or equal to the threshold, the electronic device 1000 may determine the first preliminary image as the first image after the current time point corresponding to the first time. For example, the electronic device 1000 may generate the image after the current time point until the similarity to the scenario corresponding to the original image satisfies a preset level or higher.

Hereinafter, the method of calculating the similarity between the generated image and the scenario for the original image is described in greater detail with reference to FIG. 17B.

In operation S1721 of FIG. 17B, the electronic device 1000 according to an embodiment of the disclosure may identify, as the first similarity, a maximum value among the similarities between each of a plurality of sentences in the scenario corresponding to the original image after the current time point corresponding to the first part and the obtained first preliminary image after the current time point.

In an embodiment of the disclosure, the electronic device 1000 may calculate the similarity between the generated image and the scenario for the original image through the similarity calculation module described above with reference to FIG. 4. The electronic device 1000 may calculate the similarity between the generated image and the scenario for the original image through Equation 1 below.

$$sim ( v , {s}_{i} ) = \frac{{F}_{v} ( v ) \cdot {F}_{t} ( {s}_{i} )}{‖ {F}_{v} ( v ) ‖ ‖ {F}_{t} ( {s}_{i} ) ‖} \qquad [ Equation 1 ]$$

In Equation 1, the length of the image generated at once by the second AI model may be represented by t∈[Tₘᵢₙ, Tₘₐₓ]. The image generated at once by the second AI model is represented by v. Each sentence in the scenario corresponding to the original image after the current time point may be represented by: sᵢ(i=1, 2, . . . , S). In a model trained using pairs of time-series images and text, a time-series image encoding structure is represented by Fᵥ and a text encoding structure is represented by Fₜ. Accordingly, a similarity between Fᵥ(v) and Fₜ(sᵢ) may be calculated through Equation 1 above. In other words, in Equation 1, sim(v, sᵢ) may refer to the similarity between the image of a certain length generated at once by the second AI model and each sentence of the scenario for the original image after the current time point. In calculating the similarity, time-series image embedding data obtained by encoding a time-series image may be used and text embedding data obtained by encoding text may be used.

In Equation 1, sim(v, sᵢ) may be used to calculate a cosine similarity between the two vectors Fᵥ(v) and Fₜ(sᵢ). The similarity calculated in Equation 1 may have a real number range between −1 and 1. For example, the similarity calculated in Equation 1 is closer to 1 as the two vectors Fᵥ(v) and Fₜ(sᵢ) have similar contents and is closer to −1 as the two vectors Fᵥ(v) and Fₜ(sᵢ) have opposite contents. When the two vectors Fᵥ(v) and Fₜ(sᵢ) are closer to 0, it may indicate a state in which the two vectors Fᵥ(v) and Fₜ(sᵢ) are independent and irrelevant. The method of calculating the similarity is not limited to Equation 1. A portion of Equation 1 may be modified so that the similarity has a real value between 0 and 1, or the similarity may be calculated in a method other than the cosine similarity.

In the disclosure, an “encoder” may be trained to find the relationship between text and an image and generate a joint vector representation between the text and the image. The encoder may be implemented using a known neural network architecture capable of processing the text and the image or by modifying the known neural network architecture. For example, the encoder may be implemented based on a multimodal model, but the disclosure is not limited thereto. The encoder may include a “time-series image encoder” for encoding time-series image data and a “text encoder” for encoding text data.

For example, the electronic device 1000 may obtain the time-series image embedding data by encoding the time-series image through the time-series image encoder. For example, the electronic device 1000 may obtain the text embedding data by encoding the text through the text encoder.

In an embodiment of the disclosure, i may have continuous values rather than a single value. For example, in determining the similarity between the image generated at once by the second AI model and the scenario corresponding to the original image after the current time point using Equation 1, the determination may be made based on a portion of the scenario including a plurality of sentences. For example, in determining the similarity between the image generated at once by the second AI model and the scenario for the original image after the current time point using Equation 2, the determination may be made based on a portion of the scenario including a plurality of sentences.

$${i}^{′} = {arg max}_{i ∈ I} ( sim ( v , {s}_{I} ) ) where max ( sim ( v , {s}_{{i}^{′}} ) ) \geq σ . \qquad [ Equation 2 ]$$

In Equation 2, when sim(v, sᵢ) for a set of continuous values I∈[i,i+1, . . . , i+k] is greater than or equal to a predefined threshold σ, it may refer, for example, to a similarity to a scenario of a certain section being determined as being satisfied. In other words, the similarity to the scenario including i^{th} to (i+k)^{th} sentences may be determined as a similarity to an i′^{th} sentence corresponding to a maximum value among the similarities for the i^{th} to (i+k)^{th} sentences. Therefore, when the image generated at once by the second AI model has a similarity greater than or equal to a threshold for any sentence in a portion of the scenario, the image generated at once by the second AI model may be determined as satisfying the similarity condition and a next time-series image may be generated. The generated next time-series image may be used to determine the similarity to a certain section of the scenario starting from an (i′+1)^{th} sentence, which is a new starting time point in the scenario. In determining the similarity between the generated next time-series image and a certain section of the scenario starting from the (i′+1)^{th} sentence (e.g., (i′+1)^{th} to (i′+1+k)^{th} sentences), the process of Equation 2 may be performed. The process of Equation 2 may be repeatedly performed until i≥S.

In Equation 2, as σ has a larger value, this may lead to the generation of an image that is similar to the original image after the current time point. As σ has a smaller value, this may lead to the generation of an image with a relatively small relationship with the original image after the current time point. In Equation 2, as k has a larger value, more portions may skip the verification of similarity to the scenario of the original image with respect to the original image after the current time point. As k has a smaller value, the verification of similarity to the scenario of the original image may be performed more densely.

Referring to FIG. 18, after the electronic device 1000 identifies the first preliminary image after the current time point, which is obtained in operation S1750 of FIG. 17A, as the first image after the current time point corresponding to the first time, the electronic device 1000 may proceed to operation S1810 of FIG. 18 to obtain a second preliminary image after the current time point corresponding to a second time after the first time through the second AI model. For example, the electronic device 1000 may generate the first preliminary image after the current time point and may determine the generated first preliminary image as the first image after the current time point corresponding to the first time. For example, the electronic device 1000 may generate the second preliminary image after the current time point corresponding to the second time after the first time through the second AI model.

In operation S1820 of FIG. 18, the electronic device 1000 may calculate a second similarity between the scenario corresponding to the original image after the current time point corresponding to the second part after the first part and the obtained second preliminary image after the current time point. Accordingly, in generating the image after the current time point in time series, the electronic device 1000 may also sequentially take into account the scenario corresponding to the original image after the current time point.

In operation S1830 of FIG. 18, the electronic device 1000 may identify whether the calculated second similarity is greater than or equal to a threshold. When it is identified in operation S1830 that the second similarity is less than the threshold (“No” in operation S1830), the electronic device 1000 may proceed to operation S1840 to re-obtain the second preliminary image after the current time point corresponding to the second time through the second AI model. For example, when it is identified that the calculated second similarity is less than the threshold, the electronic device 1000 may re-generate the second preliminary image after the current time point corresponding to the second time through the second AI model.

When it is identified in operation S1830 that the second similarity is greater than or equal to the threshold (“Yes” in operation S1830), the electronic device 1000 may proceed to operation S1850 to identify the obtained second preliminary image after the current time point as the second image after the current time point corresponding to the second time. For example, when it is identified that the calculated second similarity is greater than or equal to the threshold, the electronic device 1000 may determine the second preliminary image, which is the reference for the calculated second similarity, as the second image after the current time point corresponding to the second time. The electronic device 1000 according to an embodiment of the disclosure may generate the image after the current time point until the similarity to the scenario for the original image satisfies a preset level or higher. Accordingly, the electronic device 1000 may generate a natural image as a whole by obtaining the image after the current time point with reduced disparity from the image prior to the current time point.

The method described above with reference to FIG. 17B is equally applied to the method of calculating the second similarity in FIG. 18, and therefore, a detailed description thereof may not be repeated here.

In FIGS. 17A to 18, the operation of generating the first image of the section corresponding to the first time and the second image of the section corresponding to the second time is briefly illustrated, and the same method may be used to generate the image of the section after the second time.

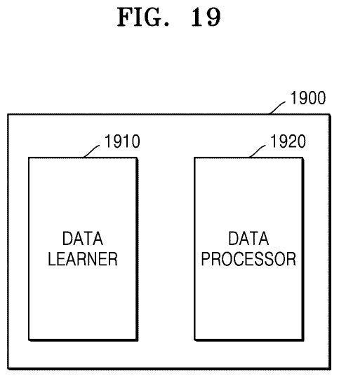

FIG. 19 is a block diagram illustrating an example configuration of a processor in terms of learning and processing of a neural network according to various embodiments.

Referring to FIG. 19, a processor 1900 according to an embodiment of the disclosure may include a data learner 1910 and a data processor 1920.

To train a first AI model or a third AI model according to an embodiment of the disclosure, the data learner 1910 may include various circuitry and/or executable program instructions and learn a criterion for generating, from an input image, a knowledge graph corresponding to the input image (e.g., a knowledge graph for the input image) and a scenario corresponding to the input image (e.g., a scenario for the input image). The data learner 1910 may learn a criteria regarding which information (e.g., object, text, or voice information) of the input image is used to generate the knowledge graph corresponding to the input image and the scenario corresponding to the input image. The data learner 1910 may learn a criteria regarding how to generate the knowledge graph and the scenario using pieces of information about the input image. The data learner 1910 may obtain data (e.g., images) to be used for learning and may learn the criterion for generating, from the input image, the knowledge graph corresponding to the input image and the scenario corresponding to the input image by applying the obtained data to a data processing model (the first AI model or the third AI model).

To train a second AI model according to an embodiment of the disclosure, the data learner 1910 may learn a criteria for generating an image after a current time point from various pieces of information corresponding to the input image (e.g., a knowledge graph for the image prior to the current time point, a scenario for the image prior to the current time point, and input information about image modification after the current time point). The data learner 1910 may learn a criteria regarding which information of an image is used to generate a changed current time point image. Furthermore, the data learner 1910 may learn a criteria regarding how to generate the image after the current time point using pieces of information about the image. The data learner 1910 may obtain data to be used for learning (e.g., data regarding an image and image modification) and may learn a criterion for generating the image after the current time point from various pieces of information corresponding to the input image by applying the obtained data to the data processing model (the second AI model).

The data processing models (e.g., first to ninth AI models) may be constructed taking into account the application field of the recognition model, the purpose of learning, or the computer performance of the device. The data processing models may be, for example, neural network-based models. For example, models, such as a DNN, an RNN, or a BRDNN, may be used as the data processing models, but the disclosure is not limited thereto.

The data learner 1910 may train the data processing models using, for example, learning algorithms, such as error back-propagation or gradient descent.

The data learner 1910 may train the data processing model through, for example, supervised learning using training data as input values. The data learner 1910 may train the data processing model through, for example, unsupervised learning, which discovers the criteria for data processing, by learning the types of data required for data processing on its own without any supervision. Furthermore, the data learner 1910 may train the data processing model through, for example, reinforcement learning using feedback on whether a result value according to learning is correct.

When the data processing model is trained, the data learner 1910 may store the trained data processing model. In this case, the data learner 1910 may store the trained data processing models in memory of a computing device. Alternatively, the data learner 1910 may store the trained data processing model in memory of a server connected to the computing device via a wired or wireless network.

The data processor 1920 may include various circuitry and input an image to the data processing model including the trained first or third AI model, and the data processing model may output, as a result value, information corresponding to a knowledge graph for the image or a scenario for the image. The output result value may be used to update the data processing model including the first AI model or the third AI model.

The data processor 1920 may input the information corresponding to the image (e.g., the knowledge graph for the image prior to the current time point, the scenario for the image prior to the current time point, and the input information about image modification after the current time point) to the data processing model including the trained second AI model, and the data processing model may output a new image after the current time point as the result value. The output result value may be used to update the data processing model including the second AI model.

At least one of the data learner 1910 or the data processor 1920 may be manufactured in the form of at least one hardware chip and loaded on a computing device. For example, at least one of the data learner 1910 or the data processor 1920 may be manufactured and loaded in the form of a dedicated hardware chip for AI, or may be manufactured and loaded as a portion of an existing general-purpose processor (e.g., a central processing unit (CPU) or an application processor) or a dedicated graphics processor (e.g., a graphics processing unit (GPU)). In this connection, the detailed descriptions above with respect to the processor 110 apply equally to the data processor 1920.

Model information constructed by the data learner 1910 may be provided to the data processor 1920 in a wired or wireless manner, and data input to the data processor 1920 may be provided to the data learner 1910 as additional training data in a wired or wireless manner.

At least one of the data learner 1910 or the data processor 1920 may be implemented as a software module. When at least one of the data learner 1910 or the data processor 1920 is implemented as a software module (or a program module including instructions), the software module may be stored in a non-transitory computer readable medium that is readable by a computer. In this case, at least one software module may be provided by an operating system (OS) or a certain application. Alternatively, a portion of at least one software module may be provided by the OS, and a remaining portion of at least one software module may be provided by the certain application.

The data learner 1910 and the data processor 1920 may be loaded on a single computing device, or may be loaded on separate computing devices. For example, one of the data learner 1910 and the data processor 1920 may be included in a computing device, and the other may be included in a server.

For example, the data learner 1910 and the data processor 1920 may be loaded on a user computing device so that both learning and data processing may be performed on the user computing device.

For example, the data learner 1910 may be loaded on the server and trained, and then, the data processor 1920 including the trained model may be loaded on the user computing device.

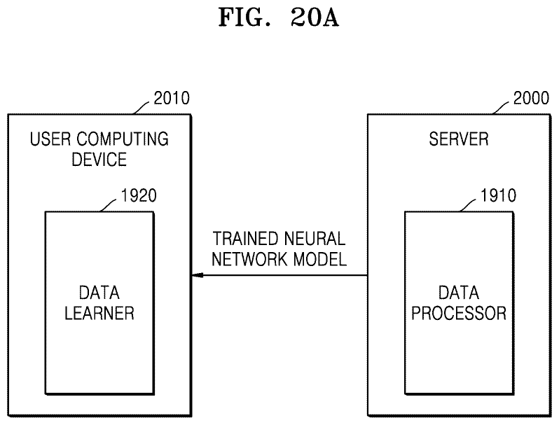

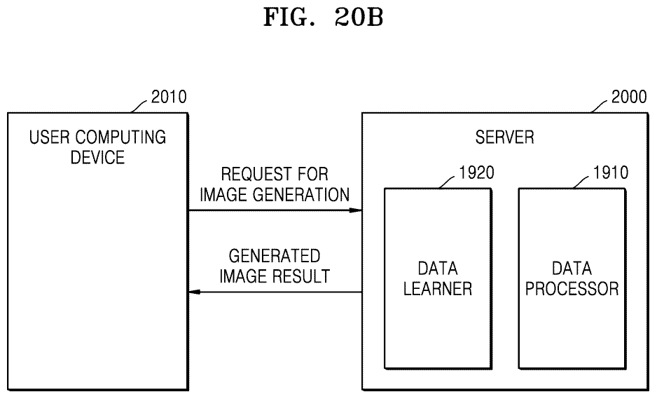

FIG. 20A is a diagram illustrating an example in which a data learner 1910 is loaded on a server 2000 and a data processor 1920 is loaded on a user computing device 2010, according to various embodiments.

Referring to FIG. 20A, the server 2000 may obtain a generation model by learning a method of generating a new image according to the method provided in the disclosure using the data learner 1910. The server 2000 may provide a trained neural network model to the user computing device 2010. The user computing device 2010 may implement the data processor 1920 using the trained neural network model received from the server 2000. When a user wants to generate an image, the user computing device 2010 may generate a new image according to a user request using the loaded data processor 1920 on its own without the need for communication with the server 2000 and may output the new image on a display of the user computing device 2010.

FIG. 20B is a diagram illustrating an example in which both the data learner 1910 and the data processor 1920 are loaded on the server 2000, according to various embodiments.

Referring to FIG. 20B, both the data learner 1910 and the data processor 1920 are loaded on the server 2000. Accordingly, the server 2000 may obtain a generative model by learning the method of generating the new image according to the method provided in the disclosure using the data learner 1910, and may implement the data processor 1920 using the obtained generative model.

When a user wants to generate a new image, the user computing device 2010 may transmit a request for image generation to the server, and the server 2000 may generate an image in response to a user request using the loaded data processor 1920 and may transmit the generated image to the user computing device 2010 so that the generated image may be displayed on the display of the user computing device 2010.

According to an example embodiment of the disclosure, a method of displaying an image may be provided.

According to an example embodiment of the disclosure, the method may include obtaining (S210) an image prior to a current time point, based on an input (e.g., a user input) corresponding to a request for image modification while displaying the image.

According to an example embodiment of the disclosure, the method may include obtaining (S220) a knowledge graph corresponding to the image prior to the current time point and a scenario corresponding to the image prior to the current time point through a first AI model, based on the obtained image prior to the current time point.

According to an example embodiment of the disclosure, the method may include obtaining (S230) an image after the current time point through a second AI model, based on the knowledge graph corresponding to the image prior to the current time point, the scenario corresponding to the image prior to the current time point, and information corresponding to the image modification, according to the information corresponding to the image modification related to the input.

According to an example embodiment of the disclosure, the obtaining (S220) of the knowledge graph corresponding to the image prior to the current time point and the scenario corresponding to the image prior to the current time point through the first AI model may include obtaining (S510) at least one of an object, text, and voice from the image prior to the current time point.

According to an example embodiment of the disclosure, the obtaining (S220) of the knowledge graph corresponding to the image prior to the current time point and the scenario corresponding to the image prior to the current time point through the first AI model may include obtaining (S520) information corresponding to the image prior to the current time point, including the obtained at least one of the object, the text, and the voice.

According to an example embodiment of the disclosure, the obtaining (S220) of the knowledge graph corresponding to the image prior to the current time point and the scenario corresponding to the image prior to the current time point through the first AI model may include obtaining (S530) the knowledge graph corresponding to the image prior to the current time point and the scenario corresponding to the image prior to the current time point through the first AI model, based on the information corresponding to the image prior to the current time point.

According to an example embodiment of the disclosure, the obtaining (S220) of the knowledge graph corresponding to the image prior to the current time point and the scenario corresponding to the image prior to the current time point through the first AI model may include obtaining (S740) an image corresponding to at least one entity included in the image prior to the current time point through the first AI model, based on the information corresponding to the image prior to the current time point.

According to an example embodiment of the disclosure, the obtaining (S230) of the image after the current time point through the second AI model may include obtaining (S1110) an updated knowledge graph from the knowledge graph corresponding to the image prior to the current time point, based on an input corresponding to modification of information corresponding to at least one entity in the knowledge graph corresponding to the image prior to the current time point.

According to an example embodiment of the disclosure, the obtaining (S230) of the image after the current time point through the second AI model may further include obtaining (S1310) an image generation prompt, based on the scenario corresponding to the image prior to the current time point and the updated knowledge graph.

According to an example embodiment of the disclosure, the obtaining (S230) of the image after the current time point through the second AI model may further include obtaining the image after the current time point through the second AI model, based on the image generation prompt.

According to an example embodiment of the disclosure, the obtaining (S230) of the image after the current time point through the second AI model may include obtaining (S910) a changed current time point image, based on an input corresponding to modification of an image corresponding to at least one entity in an image at the current time point.

According to an example embodiment of the disclosure, the obtaining (S230) of the image after the current time point through the second AI model may further include generating (S1310) the image generation prompt, based on the scenario corresponding to the image prior to the current time point and the updated knowledge graph.

According to an example embodiment of the disclosure, the obtaining (S230) of the image after the current time point through the second AI model may further include obtaining (S1320) the image after the current time point through the second AI model, based on the image generation prompt and the changed current time point image.

According to an example embodiment of the disclosure, the obtaining (S230) of the image after the current time point through the second AI model may include obtaining (S1510) an original image after the current time point.

According to an example embodiment of the disclosure, the obtaining (S230) of the image after the current time point through the second AI model may include obtaining (S1520) a scenario corresponding to the original image after the current time point through a third AI model.

According to an example embodiment of the disclosure, the obtaining (S230) of the image after the current time point through the second AI model may further include obtaining (S1530) the image after the current time point, based on a similarity to the scenario corresponding to the original image after the current time point.

According to an example embodiment of the disclosure, the obtaining (S1530) of the image after the current time point, based on the similarity to the scenario corresponding to the original image after the current time point, may further include obtaining (S1710) a first preliminary image after the current time point corresponding to a first time through the second AI model.

According to an example embodiment of the disclosure, the obtaining (S1530) of the image after the current time point, based on the similarity to the scenario corresponding to the original image after the current time point, may further include calculating (S1720) a first similarity between the scenario corresponding to the original image after the current time point corresponding to the first part and the obtained first preliminary image after the current time point.

According to an example embodiment of the disclosure, the obtaining (S1530) of the image after the current time point, based on the similarity to the scenario corresponding to the original image after the current time point, may further include, based on the first similarity being less than a threshold, re-obtaining (S1740) the first preliminary image after the current time point corresponding to the first time through the second AI model.

According to an example embodiment of the disclosure, the obtaining (S1530) of the image after the current time point, based on the similarity to the scenario corresponding to the original image after the current time point, may further include, based on the first similarity being greater than or equal to the threshold, identifying (S1750), as a first image after the current time point corresponding to the first time, the obtained first preliminary image after the current time point.

According to an example embodiment of the disclosure, in the calculating (S1720) of the first similarity, a maximum value among similarities between each of a plurality of sentences in the scenario corresponding to the original image after the current time point corresponding to the first part and the obtained first preliminary image after the current time point may be identified as the first similarity.

According to an example embodiment of the disclosure, the obtaining (S1530) of the image after the current time point, based on the similarity to the scenario corresponding to the original image after the current time point, may include, when the first image after the current time point is identified, generating (S1810) a second preliminary image after the current time point corresponding to a second time after the first time through the second AI model.

According to an example embodiment of the disclosure, the obtaining (S1530) of the image after the current time point, based on the similarity to the scenario corresponding to the original image after the current time point, may include calculating (S1820) a second similarity between the scenario corresponding to the original image after the current time point corresponding to the second part after the first part and the obtained second preliminary image after the current time point.

According to an example embodiment of the disclosure, the obtaining (S1530) of the image after the current time point, based on the similarity to the scenario corresponding to the original image after the current time point, may include, based on the second similarity being less than the threshold, re-obtaining (S1840) the second preliminary image after the current time point corresponding to the second time through the second AI model.

According to an example embodiment of the disclosure, the obtaining (S1530) of the image after the current time point, based on the similarity to the scenario corresponding to the original image after the current time point, may include, based on the second similarity being greater than or equal to the threshold, identifying (S1850) the obtained second preliminary image after the current time point as a second image after the current time point corresponding to the second time.

According to an example embodiment of the disclosure, an electronic device 1000 may be provided.

According to an example embodiment of the disclosure, the electronic device 1000 may include at least one processor 110 and memory 120 storing a plurality of instructions.

According to an example embodiment of the disclosure, the plurality of instructions may, when executed by the at least one processor 110 individually or collectively, cause the electronic device 1000 to obtain an image prior to a current time point, based on an input (e.g., a user input) corresponding to a request for image modification while displaying the image.

According to an example embodiment of the disclosure, the plurality of instructions may, when executed by the at least one processor 110 individually or collectively, cause the electronic device 1000 to, based on the obtained image prior to the current time point, obtain a knowledge graph corresponding to the image prior to the current time point and a scenario corresponding to the image prior to the current time point through a first AI model.

According to an example embodiment of the disclosure, the plurality of instructions may, when executed by the at least one processor 110 individually or collectively, cause the electronic device 1000 to, according to the information corresponding to the image modification related to the input, obtain an image after the current time point through a second AI model, based on the knowledge graph corresponding to the image prior to the current time point, the scenario corresponding to the image prior to the current time point, and information corresponding to the image modification.

According to an example embodiment of the disclosure, the plurality of instructions may, when executed by the at least one processor 110 individually or collectively, cause the electronic device 1000 to obtain at least one of an object, text, or voice from the image prior to the current time point.

According to an example embodiment of the disclosure, the plurality of instructions may, when executed by the at least one processor 110 individually or collectively, cause the electronic device 1000 to obtain information corresponding to the image prior to the current time point, including the obtained at least one of the object, the text, or the voice.

According to an example embodiment of the disclosure, the plurality of instructions may, when executed by the at least one processor 110 individually or collectively, cause the electronic device 1000 to obtain the knowledge graph corresponding to the image prior to the current time point and the scenario corresponding to the image prior to the current time point through the first AI model, based on the information corresponding to the image prior to the current time point.

According to an example embodiment of the disclosure, the plurality of instructions may, when executed by the at least one processor 110 individually or collectively, cause the electronic device 1000 to obtain an updated knowledge graph from the knowledge graph corresponding to the image prior to the current time point, based on an input corresponding to modification of information corresponding to at least one entity in the knowledge graph corresponding to the image prior to the current time point.

According to an example embodiment of the disclosure, the plurality of instructions may, when executed by the at least one processor 110 individually or collectively, cause the electronic device 1000 to obtain an image generation prompt, based on the scenario corresponding to the image prior to the current time point and the updated knowledge graph.

According to an example embodiment of the disclosure, the plurality of instructions may, when executed by the at least one processor 110 individually or collectively, cause the electronic device 1000 to obtain the image after the current time point through the second AI model, based on the image generation prompt.

According to an example embodiment of the disclosure, the plurality of instructions may, when executed by the at least one processor 110 individually or collectively, cause the electronic device 1000 to obtain a changed current time point image, based on an input corresponding to modification of an image corresponding to at least one entity in an image at the current time point.

According to an example embodiment of the disclosure, the plurality of instructions may, when executed by the at least one processor 110 individually or collectively, cause the electronic device 1000 to generate an image generation prompt, based on the scenario corresponding to the image prior to the current time point and the updated knowledge graph.

According to an example embodiment of the disclosure, the plurality of instructions may, when executed by the at least one processor 110 individually or collectively, cause the electronic device 1000 to obtain the image after the current time point through the second AI model, based on the image generation prompt and the changed current time point image.

According to an example embodiment of the disclosure, the plurality of instructions may, when executed by the at least one processor 110 individually or collectively, cause the electronic device 1000 to obtain an original image after the current time point.

According to an example embodiment of the disclosure, the plurality of instructions may, when executed by the at least one processor 110 individually or collectively, cause the electronic device 1000 to obtain a scenario corresponding to the original image after the current time point through a third AI model.

According to an example embodiment of the disclosure, the plurality of instructions may, when executed by the at least one processor 110 individually or collectively, cause the electronic device 1000 to obtain the image after the current time point, based on a similarity to the scenario corresponding to the original image after the current time point.

According to an example embodiment of the disclosure, the plurality of instructions may, when executed by the at least one processor 110 individually or collectively, cause the electronic device 1000 to obtain a first preliminary image after the current time point corresponding to a first time through the second AI model.

According to an example embodiment of the disclosure, the plurality of instructions may, when executed by the at least one processor 110 individually or collectively, cause the electronic device 1000 to calculate a first similarity between the scenario corresponding to the original image after the current time point corresponding to the first part and the obtained first preliminary image after the current time point.

According to an example embodiment of the disclosure, the plurality of instructions may, when executed by the at least one processor 110 individually or collectively, cause the electronic device 1000 to, based on the first similarity being less than a threshold, re-obtain the first preliminary image after the current time point corresponding to the first time through the second AI model.

According to an example embodiment of the disclosure, the plurality of instructions may, when executed by the at least one processor 110 individually or collectively, cause the electronic device 1000 to, based on the first similarity being greater than or equal to the threshold, identify the obtained first preliminary image after the current time point as a first image after the current time point corresponding to the first time.

According to an example embodiment of the disclosure, the plurality of instructions may, when executed by the at least one processor 110 individually or collectively, cause the electronic device 1000 to, when the first image after the current time point corresponding to the first time is identified, generate a second preliminary image after the current time point corresponding to a second time after the first time through the second AI model.

According to an example embodiment of the disclosure, the plurality of instructions may, when executed by the at least one processor 110 individually or collectively, cause the electronic device 1000 to identify, as the first similarity, a maximum value among similarities between each of a plurality of sentences in the scenario corresponding to the original image after the current time point corresponding to the first part and the obtained first preliminary image after the current time point.

According to an example embodiment of the disclosure, a computer-readable recording medium having recorded thereon a program for causing a computer to perform the operating method of the electronic device 1000 may be provided.

A machine-readable storage medium may be provided in the form of a non-transitory storage medium. The ‘non-transitory storage medium’ is a tangible device and does not include a signal (e.g., electromagnetic waves). This term does not distinguish between a case where data is semi-permanently stored in a storage medium and a case where data is temporarily stored in a storage medium. For example, the ‘non-transitory storage medium’ may include a buffer in which data is temporarily stored.

A method according to an embodiment of the disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method of displaying an image, the method comprising:
obtaining an image prior to a current time point, based on an input corresponding to a request for image modification while displaying the image;
obtaining a knowledge graph corresponding to the image prior to the current time point and a scenario corresponding to the image prior to the current time point through a first artificial intelligence (AI) model, based on the obtained image prior to the current time point; and
obtaining an image after the current time point through a second AI model, based on the knowledge graph corresponding to the image prior to the current time point, the scenario corresponding to the image prior to the current time point, and information corresponding to the image modification, according to the information corresponding to the image modification related to the input.

2. The method of claim 1, wherein the obtaining of the knowledge graph corresponding to the image prior to the current time point and the scenario corresponding to the image prior to the current time point through the first AI model comprises:
obtaining at least one of an object, text, and voice from the image prior to the current time point;
obtaining information corresponding to the image prior to the current time point, including the obtained at least one of the object, the text, and the voice; and
obtaining the knowledge graph corresponding to the image prior to the current time point and the scenario corresponding to the image prior to the current time point through the first AI model, based on the information corresponding to the image prior to the current time point.

3. The method of claim 1, wherein the obtaining of the knowledge graph corresponding to the image prior to the current time point and the scenario corresponding to the image prior to the current time point through the first AI model further comprises obtaining an image corresponding to at least one entity included in the image prior to the current time point through the first AI model, based on the information corresponding to the image prior to the current time point.

4. The method of claim 1, wherein the obtaining of the image after the current time point through the second AI model comprises obtaining an updated knowledge graph from the knowledge graph corresponding to the image prior to the current time point, based on an input corresponding to modification of information corresponding to at least one entity in the knowledge graph corresponding to the image prior to the current time point.

5. The method of claim 4, wherein the obtaining of the image after the current time point through the second AI model further comprises:
obtaining an image generation prompt, based on the scenario corresponding to the image prior to the current time point and the updated knowledge graph; and
obtaining the image after the current time point through the second AI model, based on the image generation prompt.

6. The method of claim 1, wherein the obtaining of the image after the current time point through the second AI model comprises obtaining a changed current time point image, based on an input corresponding to modification of an image corresponding to at least one entity in an image at the current time point.

7. The method of claim 6, wherein the obtaining of the image after the current time point through the second AI model further comprises:
generating the image generation prompt, based on the scenario corresponding to the image prior to the current time point and the updated knowledge graph; and
obtaining the image after the current time point through the second AI model, based on the image generation prompt and the changed current time point image.

8. The method of claim 1, wherein the obtaining of the image after the current time point through the second AI model comprises:
obtaining an original image after the current time point;
obtaining a scenario corresponding to the original image after the current time point through a third AI model; and
obtaining the image after the current time point, based on a similarity to the scenario corresponding to the original image after the current time point.

9. The method of claim 8, wherein the obtaining of the image after the current time point, based on the similarity to the scenario corresponding to the original image after the current time point, further comprises:
obtaining a first preliminary image after the current time point corresponding to a first time through the second AI model;
calculating a first similarity between the scenario corresponding to the original image after the current time point corresponding to a first part and the obtained first preliminary image after the current time point;
based on the first similarity being less than a threshold, re-obtaining the first preliminary image after the current time point corresponding to the first time through the second AI model; and
based on the first similarity being greater than or equal to the threshold, identifying, as a first image after the current time point corresponding to the first time, the obtained first preliminary image after the current time point.

10. The method of claim 9, wherein, in the calculating of the first similarity, a maximum value among similarities between each of a plurality of sentences in the scenario corresponding to the original image after the current time point corresponding to the first part and the obtained first preliminary image after the current time point is identified as the first similarity.

11. An electronic device for displaying an image, the electronic device comprising:
at least one processor, comprising processing circuitry; and
memory storing a plurality of instructions,
wherein the at least one processor individually or collectively executes the plurality of instructions to cause the electronic device to:
obtain an image prior to a current time point, based on an input corresponding to a request for image modification while displaying the image;
based on the obtained image prior to the current time point, obtain a knowledge graph corresponding to the image prior to the current time point and a scenario corresponding to the image prior to the current time point through a first artificial intelligence (AI) model; and
according to information corresponding to the image modification related to the input, obtain an image after the current time point through a second AI model, based on the knowledge graph corresponding to the image prior to the current time point, the scenario corresponding to the image prior to the current time point, and information corresponding to the image modification.

12. The electronic device of claim 11, wherein the at least one processor individually or collectively executes the plurality of instructions to cause the electronic device to:
obtain at least one of an object, text, or voice from the image prior to the current time point;
obtain information corresponding to the image prior to the current time point, including the obtained at least one of the object, the text, or the voice; and
obtain the knowledge graph corresponding to the image prior to the current time point and the scenario corresponding to the image prior to the current time point through the first AI model, based on the information corresponding to the image prior to the current time point.

13. The electronic device of claim 12, wherein the at least one processor individually or collectively executes the plurality of instructions to cause the electronic device to obtain an updated knowledge graph from the knowledge graph corresponding to the image prior to the current time point, based on an input corresponding to modification of information corresponding to at least one entity in the knowledge graph corresponding to the image prior to the current time point.

14. The electronic device of claim 13, wherein the at least one processor individually or collectively executes the plurality of instructions to cause the electronic device to:
obtain an image generation prompt, based on the scenario corresponding to the image prior to the current time point and the updated knowledge graph; and
obtain the image after the current time point through the second AI model, based on the image generation prompt.

15. The electronic device of claim 9, wherein the at least one processor individually or collectively executes the plurality of instructions to cause the electronic device to obtain a changed current time point image, based on an input corresponding to modification of an image corresponding to at least one entity in an image at the current time point.

16. The electronic device of claim 15, wherein the at least one processor individually or collectively executes the plurality of instructions to cause the electronic device to:
generate an image generation prompt, based on the scenario corresponding to the image prior to the current time point and the updated knowledge graph; and
obtain the image after the current time point through the second AI model, based on the image generation prompt and the changed current time point image.

17. The electronic device of claim 11, wherein the at least one processor individually or collectively executes the plurality of instructions to cause the electronic device to:
obtain an original image after the current time point;
obtain a scenario corresponding to the original image after the current time point through a third AI model; and
obtain the image after the current time point, based on a similarity to the scenario corresponding to the original image after the current time point.

18. The electronic device of claim 17, wherein the at least one processor individually or collectively executes the plurality of instructions to cause the electronic device to:
obtain a first preliminary image after the current time point corresponding to a first time through the second AI model;
calculate a first similarity between the scenario corresponding to the original image after the current time point corresponding to a first part and the obtained first preliminary image after the current time point;
based on the first similarity being less than a threshold, re-obtain the first preliminary image after the current time point corresponding to the first time through the second AI model; and
based on the first similarity being greater than or equal to the threshold, identify the obtained first preliminary image after the current time point as a first image after the current time point corresponding to the first time.

19. The electronic device of claim 18, wherein the at least one processor individually or collectively executes the plurality of instructions to cause the electronic device to identify, as the first similarity, a maximum value among similarities between each of a plurality of sentences in the scenario corresponding to the original image after the current time point corresponding to the first part and the obtained first preliminary image after the current time point.

20. A non-transitory computer-readable recording medium storing instructions that, when executed by at least one processor of an electronic device, cause the electronic device to:
obtain an image prior to a current time point, based on an input corresponding to a request for image modification while displaying the image;
based on the obtained image prior to the current time point, obtain a knowledge graph corresponding to the image prior to the current time point and a scenario corresponding to the image prior to the current time point through a first artificial intelligence (AI) model; and
according to information corresponding to the image modification related to the input, obtain an image after the current time point through a second AI model, based on the knowledge graph corresponding to the image prior to the current time point, the scenario corresponding to the image prior to the current time point, and information corresponding to the image modification.
